(19) United States
(12) Patent Application Publication
(10) Pub. No.: US 2026/0176394 A1
(43) Pub. Date: Jun. 25, 2026

(54) RECOVERY OF HYDROXYL-CONTAINING COMPOUNDS AND (METH)ACRYLATE MONOMERS FROM 3D PRINTED POLYMERIC MATERIALS

(71) Applicant: Align Technology, Inc., San Jose, CA (US)

(72) Inventors: Xiance Wang, Santa Clara, CA (US); Jian Chang, San Francisco, CA (US); Iva Petrovic, Palo Alto, CA (US); Yunching Peng, San Jose, CA (US); Ming Ren, Belmont, CA (US); Lance Robert Pickens, Campbell, CA (US); Umesh Upendra Choudhary, Scotts Valley, CA (US); Garrett Frederic Bass, Campbell, CA (US); Michael Christopher Cole, San Jose, CA (US)

(21) Appl. No.: 19/240,333

(22) Filed: Jun. 17, 2025

Related U.S. Application Data
(60) Provisional application No. 63/660,866, filed on Jun. 17, 2024.
(60) Provisional application No. 63/661,376, filed on Jun. 18, 2024.

(51) Int. Cl. C08F 220/18

(52) U.S. Cl. CPC C08F 220/1804

(57) ABSTRACT

The present disclosure provides methods for recovering reactive diluent components from 3D printed crosslinked polymeric materials. The reactive diluent components can be recovered either as hydroxyl-containing compounds cleaved from pendant ester groups attached to the polymer backbone, or as (meth)acrylate monomers by cleavage of the polymer backbone itself. The recovered hydroxyl-containing compounds and (meth)acrylate monomers can be reused for the fabrication of new medical devices by 3D printing.

### PRIORITY CLAIM AND CROSS-REFERENCE

This application claims the benefit of U.S. Provisional Patent Application No. 63/660,866, filed Jun. 17, 2024 and U.S. Provisional Patent Application No. 63/661,376, filed Jun. 18, 2024, each of which is incorporated by reference herein in its entirety.

### BACKGROUND

Orthodontic procedures typically involve repositioning a patient's teeth to a desired arrangement in order to correct malocclusions and/or improve aesthetics. To achieve these objectives, orthodontic appliances such as aligners, retainers, expanders, and the like can be applied to the patient's teeth by an orthodontic practitioner and/or a patient. The appliance is configured to exert force on one or more teeth in order to effect desired tooth movements. The application of force can be periodically adjusted (e.g., by altering the appliance or using different types of appliances) in order to incrementally reposition the teeth to a desired arrangement.

Additive manufacturing, also referred to as three-dimensional (3D) printing, has been widely used to fabricate orthodontic appliances from photopolymerizable materials. This process typically involves applying a single layer of photosensitive material, curing it through controlled light exposure, and repeating this sequence layer by layer to build the final structure. The photopolymerizable materials commonly include reactive components that harden upon exposure to light. Along these, acrylate-based resins, which cure rapidly through free-radical polymerization, are frequently used due to their high photopolymerization speed.

### BRIEF SUMMARY

The present disclosure provides methods for recovering reactive diluent components from 3D printed crosslinked polymeric materials. The reactive diluents can be recovered either as hydroxyl-containing compounds cleaved from pendant ester groups attached to the polymer backbone, or as (meth)acrylate monomers by cleavage of the polymer backbone itself.

The present disclosure also provides methods for reusing the recovered hydroxyl-containing compounds by chemically converting the recovered hydroxyl-containing compounds into polymerizable compounds (i.e., monomers) suitable for use as reactive diluents in polymerizable compositions. These polymerizable compositions can be employed in the fabrication of new devices, including medical devices such as orthodontic appliances, via 3D printing.

The present disclosure further provides methods for reusing monomers as reactive diluents in polymerizable compositions, enabling the fabrication of new devices, including medical devices such as orthodontic appliances, via 3D printing.

In one aspect, provided herein is a method of recovering a hydroxyl-containing compound, including a phenol derivative or a cycloaliphatic alcohol derivative, from a 3D printed object feedstock. The method includes providing the 3D printed object feedstock comprising a crosslinked polymeric material. The crosslinked polymeric material includes an ester pendant group derived from the hydroxyl-containing compound. After transesterifying the ester pendant group with an alcohol, in the presence of a transesterification catalyst, to form a mixture comprising the hydroxyl-containing compound, the hydroxyl-containing compound is isolated from the mixture. The hydroxyl-containing compound is a compound of formula (A):

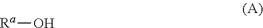

wherein R^{a} is substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl.

In some embodiments, the hydroxyl-containing compound is a phenol derivative and the ester pendant group is a phenolic ester pendant group. The method includes transesterifying the phenolic ester pendant group to form a mixture comprising the phenol derivative, and isolating the phenol derivative from the mixture. The phenol derivative is a compound of formula (I):

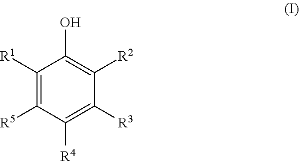

wherein R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl or substituted or unsubstituted heteroaryl

In some embodiments, the hydroxyl-containing compound is a cycloaliphatic alcohol derivative and the ester pendant group is a cycloaliphatic ester pendant group. The method includes transesterifying the cycloaliphatic ester pendant group to form a mixture comprising the cycloaliphatic alcohol derivative, and isolating the cycloaliphatic alcohol derivative from the mixture. The cycloaliphatic alcohol derivative is a compound of formula (III):

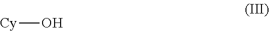

wherein Cy is substituted or unsubstituted cyclo(C₃₋₁₈) alkyl.

In still another aspect, provided herein is a method for recovering a hydroxyl-containing compound from a 3D printed object feedstock. The method includes providing the 3D printed object feedstock comprising a crosslinked polymeric material. The crosslinked polymeric material comprises an ester pendant group derived from the hydroxyl-containing compound. After transesterifying the ester pendant group with a transesterification agent comprising a metal alkoxide in a solvent to form a mixture comprising the hydroxyl-containing compound, the hydroxyl-containing compound is isolated from the mixture. The hydroxyl-containing compound is a compound of formula (A):

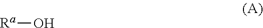

wherein R^{a} is substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl.

In some embodiments, the hydroxyl-containing compound is a phenol derivative and the ester pendant group is a phenolic ester pendant group. The method includes transesterifying the phenolic ester pendant group to form a mixture comprising the phenol derivative, and isolating the phenol derivative from the mixture. The phenol derivative is a compound of formula (I):

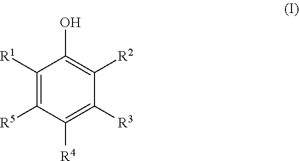

wherein R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl or substituted or unsubstituted heteroaryl.

In some embodiments, the hydroxyl-containing compound is a cycloaliphatic alcohol derivative and the ester pendant group is a cycloaliphatic ester pendant group. The method includes transesterifying the cycloaliphatic ester pendant group to form a mixture comprising the cycloaliphatic alcohol derivative, and isolating the cycloaliphatic alcohol derivative from the mixture. The cycloaliphatic alcohol derivative is a compound of formula (III):

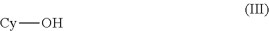

wherein Cy is substituted or unsubstituted cyclo(C₃₋₁₈) alkyl.

In still another aspect, provided herein is a method for forming a polymerizable compound. The method includes providing a curable composition; curing the curable composition to form a crosslinked polymeric material comprising an ester pendant group derived from a hydroxyl-containing compound; transesterifying the ester pendant group with a transesterification agent, optionally in the presence of a transesterification catalyst, to form a mixture comprising the hydroxyl-containing compound; isolating the hydroxyl-containing compound from the mixture; and forming the polymerizable compound by reacting the hydroxyl-containing compound with a functional group. The hydroxyl-containing compound is a compound of formula (A):

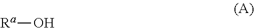

wherein R^{a} is substituted or unsubstituted aryl, substituted or unsubstituted heteroaryl, substituted or unsubstituted cyclo(C3-18) alkyl, substituted or unsubstituted cyclo(C3-18) heteroalkyl or substituted or unsubstituted C1-12 alkylene-cyclo(C3-18) heteroalkyl.

In some embodiments, the hydroxyl-containing compound is a phenol derivative and the ester pendant group is a phenolic ester pendant group. The method includes curing the curable composition to form a crosslinked polymeric material comprising the phenolic ester pendant group; transesterifying the phenolic ester pendant group to form a mixture comprising the phenol derivative; isolating the phenol derivative from the mixture; and forming a polymerizable compound by reacting the phenol derivative with a functional group. The phenol derivative is a compound of formula (I):

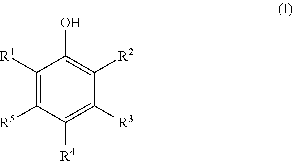

wherein R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl or substituted or unsubstituted heteroaryl.

In some embodiments, the hydroxyl-containing compound is a cycloaliphatic alcohol derivative and the ester pendant group is a cycloaliphatic ester pendant group. The method includes curing the curable composition to form a crosslinked polymeric material comprising the cycloaliphatic ester pendant group; transesterifying the cycloaliphatic ester pendant group to form a mixture comprising the cycloaliphatic alcohol derivative; isolating the cycloaliphatic alcohol derivative from the mixture; and forming a polymerizable compound by reacting the cycloaliphatic alcohol derivative with a functional group. The cycloaliphatic alcohol derivative is a compound of formula (III):

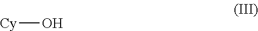

wherein Cy is substituted or unsubstituted cyclo(C₃₋₁₈) alkyl.

In still another aspect, provided herein is a method for recovering a (meth)acrylate monomer from a 3D printed object feedstock. The method includes providing the 3D printed object feedstock comprising a crosslinked polymeric material; heating the 3D printed object feedstock in the presence of a mechanical energy to depolymerize the crosslinked polymeric material, thereby providing a depolymerization product; and purifying the depolymerization product to obtain the (meth)acrylate monomer.

In still another aspect, provided herein is a method for recovering a (meth)acrylate monomer from a 3D printed object feedstock. The method includes providing the 3D printed object feedstock comprising a crosslinked polymeric material; heating the 3D printed object feedstock in the presence of a light energy to depolymerize the crosslinked polymeric material, thereby providing a depolymerized product; and purifying the depolymerization product to obtain the (meth)acrylate monomer.

In still another aspect, provided herein is a method for recovering a (meth)acrylate monomer from a 3D printed object feedstock. The method includes mixing the 3D printed object feedstock comprising a crosslinked polymeric material and a depolymerization-initiating catalyst to obtain a mixture; heating the mixture to depolymerize the crosslinked polymeric material, thereby providing a depolymerization product; and purifying the depolymerization product to obtain the (meth)acrylate monomer.

In still another aspect, provided herein is a method for recovering a (meth)acrylate monomer from a 3D printed object feedstock. The method includes providing the 3D printed object feedstock comprising a crosslinked polymeric material, the crosslinked polymeric material comprising catalyst units capable of generating radicals upon heating; heating the 3D printed object feedstock to depolymerize the crosslinked polymeric material, thereby providing a depolymerization product; and purifying the depolymerization product to obtain the (meth)acrylate monomer.

In still another aspect, provided herein is a method for recovering a (meth)acrylate monomer from a 3D printed object feedstock. The method includes providing a 3D printed object feedstock comprising a crosslinked polymeric material; heating the 3D printed object feedstock optionally in the presence of a mechanical energy, a light energy or a depolymerization-initiating catalyst to depolymerize the crosslinked polymeric material, thereby providing a depolymerization product; purifying the depolymerization product to obtain the (meth)acrylate monomer; and curing a polymerizable composition comprising the (meth)acrylate monomer to fabricate an object by 3D printing.

In the foregoing various aspects, the (meth)acrylate monomer is a compound according to formula (B):

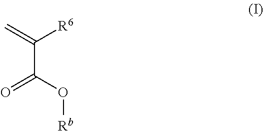

wherein R⁶ is H, substituted or unsubstituted C₁₋₃ alkyl, or halogen; and R^{b} is substituted or unsubstituted C₁₋₁₂ alkyl, substituted or unsubstituted C₁₋₁₂ heteroalkyl, substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl. The crosslinked polymeric material comprises repeating units derived from the (meth)acrylate monomer of formula (B).

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the invention are utilized, and the accompanying drawings of which:

FIG. 1 is a flow diagram illustrating a method for recovering a (meth)acrylate monomer from a 3D printed crosslinked polymeric material comprising corresponding structural units, in accordance with some embodiments of the present discourse.

FIG. 2 is a flow diagram illustrating a method for recovering a (meth)acrylate monomer from a 3D printed crosslinked polymeric material comprising corresponding structural units, in accordance with some embodiments of the present discourse.

FIG. 3 is a flow diagram illustrating a method for recovering a (meth)acrylate monomer of from a 3D printed crosslinked polymeric material comprising corresponding structural units, in accordance with some embodiments of the present discourse.

FIG. 4 is a flow diagram providing a general overview of a method for fabricating and post-processing an additively manufactured object, in accordance with embodiments of the present disclosure.

FIG. 5 illustrates a representation example of an additive manufacturing device.

FIG. 6A shows a representative example of a tooth repositioning appliance.

FIG. 6B depicts a tooth repositioning system including a plurality of appliances.

FIG. 6C is a flow diagram illustrating a method of orthodontic treatment using a plurality of appliances.

FIG. 7 is a flow diagram illustrating a method for designing an orthodontic appliance in accordance with embodiments of the present disclosure.

FIG. 8 is a flow diagram illustrating a method for digitally planning an orthodontic treatment and/or design or fabrication of an appliance, in accordance with embodiments of the present disclosure.

FIG. 9 is a diagram illustrating the thermal decomposition of an exemplary crosslinked polymeric material.

FIG. 10 illustrates TGA thermograms of exemplary crosslinked polymeric materials.

### DETAILED DESCRIPTION

3D printed objects for specific applications, such as orthodontic appliances, require thermoset materials (i.e., crosslinked polymeric materials) possessing both elasticity and stiffness. Singular polymeric materials, composed of a single polymer species, typically lack these characteristics. (Meth)acrylate monomers, such as syringyl methacrylate (SMA), adamantane methacrylate, and isobornyl methacrylate (IBOMA), have been employed as reactive diluents in polymerizable compositions (i.e., curable resins) to form polymeric networks with high glass transition temperature and modulus when co-polymerized with toughing crosslinkers.

Phenol derivatives such as syringol and guaiacol are biomass-based phenol compounds that can be functionalized with polymerizable groups (e.g., methacrylates, acrylates, epoxides, and vinyl ethers) to form monomers suitable for use as reactive diluents in curable resins for 3D printing. Although lignin-derived syringol and guaiacol are renewable, their production from lignin-rich biomass remains costly due to low pyrolysis yields and the difficulty of separating them from the complex mixture of similar compounds present in bio-oil. Additionally, the fabrication of medical devices such as orthodontic appliances using these phenol- or cycloaliphatic alcohol-based reactive diluents can be both resource- and cost-intensive. Thus, the ability to effectively recover syringol, guaiacol, or syringol/guaiacol-containing (meth)acrylates from 3D printed crosslinked polymeric materials is desirable.

### I. Definition

All terms, chemical names, expressions, and designations have their usual meanings which are well-known to those skilled in the art. As used herein, the terms “to comprise” and “comprising” are to be understood as non-limiting, i.e., other components than those explicitly named may be included.

Number ranges are to be understood as inclusive, i.e., including the indicated lower and upper limits. Furthermore, the term “about”, as used herein, and unless clearly indicated otherwise, generally refers to and encompasses plus or minus 10% of the indicated numerical value(s). For example, “about 10%” may indicate a range of 9% to 11%, and “about 1” may include the range 0.9-1.1.

As used herein, the term “polymer” generally refers to a molecule composed of repeating structural units connected by covalent chemical bonds and characterized by a substantial number of repeating units (e.g., equal to or greater than 20 repeating units and often equal to or greater than 100 repeating units and often equal to or greater than 200 repeating units) and a molecular weight greater than or equal to 5,000 Daltons (Da) or 5 kDa, such as greater than or equal to 10 kDa, 15 kDa, 20 kDa, 30 kDa, 40 kDa, 50 kDa, or 100 kDa. Polymers are commonly the polymerization product of one or more monomer precursors. The term polymer includes homopolymers, i.e., polymers consisting essentially of a single repeating monomer species. The term polymer also includes copolymers which are formed when two or more different types of monomers are linked in the same polymer. Copolymers may comprise two or more monomer subunits, and include random, block, alternating, segmented, grafted, tapered and other copolymers. The term “crosslinked polymers” generally refers to polymers having one or multiple links between at least two polymer chains, which can result from multivalent monomers forming cross-linking sites upon polymerization.

The term “oligomer” generally refers to a molecule composed of repeating structural units connected by covalent chemical bonds and characterized by a number of repeating units less than that of a polymer (e.g., equal to or less than 10 repeating units) and a lower molecular weight than polymers (e.g., less than 5,000 Da or 2,000 Da). In some cases, oligomers may be the polymerization product of one or more monomer precursors. In an embodiment, an oligomer or a monomer cannot be considered a polymer in its own right.

Oligomer and polymer mixtures can be characterized and differentiated from other mixtures of oligomers and polymers by measurements of molecular weight and molecular weight distributions.

The terms “telechelic polymer” and “telechelic oligomer” generally refer to a polymer or oligomer, the molecules of which are capable of entering, through reactive groups, into further polymerization.

The average molecular weight (M) is the average number of repeating units n times the molecular weight or molar mass (Mi) of the repeating unit. The number-average molecular weight (Mn) is the arithmetic mean, representing the total weight of the molecules present divided by the total number of molecules.

As used herein, the term “pendant group” generally refers to a side chain group that is chemically bonded (e.g., covalently bonded) to the polymer backbone. Hence, a pendant group herein refers to a substituent coupled to a polymer backbone, but not the polymer backbone part itself. The following structure shows a portion of a polymeric backbone coupled to a pendant group according to embodiments of this disclosure:

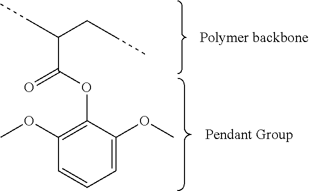

The term “reactive diluent” generally refers to a substance which reduces the viscosity of another substance, such as a monomer or curable resin. A reactive diluent may become part of another substance, such as a polymer obtained by a polymerization process. In some examples, a reactive diluent is a curable monomer which, when mixed with a curable resin, reduces the viscosity of the resultant formulation and is incorporated into the polymer that results from polymerization of the formulation.

Photoinitiators described in the present disclosure can include those that can be activated with light and initiate polymerization of the polymerizable components of the formulation. A “photoinitiator”, as used herein, may generally refer to a compound that can produce radical species and/or promote radical reactions upon exposure to radiation (e.g., UV or visible light).

The term “biocompatible,” as used herein, refers to a material that does not elicit an immunological rejection or detrimental effect, referred herein as an adverse immune response, when it is disposed within an in-vivo biological environment. For example, in embodiments a biological marker indicative of an immune response changes less than 10%, or less than 20%, or less than 25%, or less than 40%, or less than 50% from a baseline value when a human or animal is exposed to or in contact with the biocompatible material. Alternatively, immune response may be determined histologically, wherein localized immune response is assessed by visually assessing markers, including immune cells or markers that are involved in the immune response pathway, in and adjacent to the material. In an aspect, a biocompatible material or device does not observably change immune response as determined histologically. In some embodiments, the disclosure provides biocompatible devices configured for long-term use, such as on the order of weeks to months, without invoking an adverse immune response. Biological effects may be initially evaluated by measurement of cytotoxicity, sensitization, irritation and intracutaneous reactivity, acute systemic toxicity, pyrogenicity, subacute/subchronic toxicity and/or implantation. Biological tests for supplemental evaluation include testing for chronic toxicity.

“Bioinert” refers to a material that does not elicit an immune response from a human or animal when it is disposed within an in-vivo biological environment. For example, a biological marker indicative of an immune response remains substantially constant (plus or minus 5% of a baseline value) when a human or animal is exposed to or in contact with the bioinert material. In some embodiments, the disclosure provides bioinert devices.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. Specific names of compounds are intended to be exemplary, as it is known that one of ordinary skill in the art can name the same compounds differently.

It is noted that as used herein and in the appended claims, the singular forms “a”, “an”, and “the” include plural reference unless the context clearly dictates otherwise. Thus, for example, reference to “a monomer” includes a plurality of such monomers and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim.

The term “group” may refer to a functional group of a chemical compound. Groups of the present compounds refer to an atom or a collection of atoms that are a part of the compound.

Groups of the present disclosure may be attached to other atoms of the compound via one or more covalent bonds. Groups may also be characterized with respect to their valence state. The present disclosure includes groups characterized as monovalent, divalent, trivalent, etc. valence states.

The term “substituted” refers to a compound (e.g., an alkyl chain) wherein a hydrogen is replaced by another functional group or atom, as described herein.

As used herein, a broken line in a chemical structure can be used to indicate a bond to the rest of the molecule. For example, [symbol] in

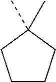

is used to designate the 1-position as the point of attachment of 1-methylcyclopentate to the rest of the molecule. Alternatively,

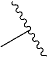

in, e.g.,

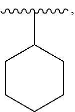 [SMILES: *C1CCCCC1]

can be used to indicate that the given moiety, the cyclohexyl moiety in this example, is attached to a molecule via the bond that is “capped” with the wavy line.

The term “alkyl” refers to a straight-chain, branched, or cyclic alkyl group. Alkyl groups include those having from 1 to 30 carbon atoms, unless otherwise defined. Thus, alkyl groups can include small alkyl groups having 1 to 3 carbon atoms, medium length alkyl groups having from 4-10 carbon atoms, as well as long alkyl groups having more than 10 carbon atoms, particularly those having 10-30 carbon atoms. The term “cycloalkyl” specifically refers to an alkyl group having a ring structure such as a ring structure comprising 3-30 carbon atoms, optionally 3-20 carbon atoms and optionally 3-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkyl groups can also carry alkyl groups. Cycloalkyl groups can include bicyclic and tricyclic alkyl groups. Alkyl groups are optionally substituted, as described herein. Substituted alkyl groups can include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Unless otherwise defined herein, substituted alkyl groups include fully halogenated or semihalogenated alkyl groups, such as alkyl groups having one or more hydrogens replaced with one or more fluorine atoms, chlorine atoms, bromine atoms and/or iodine atoms. Thus, substituted alkyl groups can include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy, and heptoxy. Alkoxy groups include substituted alkoxy groups wherein the alky portion of the groups is substituted as provided herein in connection with the description of alkyl groups. As used herein MeO— refers to CH₃O—. Moreover, a thioalkoxy group, as used herein, is an alkyl group that has been modified by linkage to a sulfur atom (instead of an oxygen) and can be represented by the formula R—S.

The term “alkenyl” refers to a straight-chain, branched, or cyclic alkenyl group. Alkenyl groups include those having 1, 2, or more double bonds and those in which two or more of the double bonds are conjugated double bonds. Unless otherwise defined herein, alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term “cycloalkenyl” specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkenyl groups can also carry alkyl groups. Cycloalkenyl groups can include bicyclic and tricyclic alkenyl groups. Alkenyl groups are optionally substituted. Unless otherwise defined herein, substituted alkenyl groups include among others those that are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups can include fully halogenated or semihalogenated alkenyl groups, such as alkenyl groups having one or more hydrogens replaced with one or more fluorine atoms, chlorine atoms, bromine atoms, and/or iodine atoms. Substituted alkenyl groups include fully fluorinated or semifluorinated alkenyl groups, such as alkenyl groups having one or more hydrogen atoms replaced with one or more fluorine atoms.

The term “aryl” refers to a group having one or more 5-, 6-, 7-, or 8-membered aromatic rings, including heterocyclic aromatic rings. The term “heteroaryl” specifically refers to an aryl group having at least one 5-, 6-, 7-, or 8-member heterocyclic aromatic ring. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocylic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent, and polyvalent groups, of the aromatic and heterocyclic aromatic groups listed herein provided in a covalently bonded configuration in the compounds of the disclosure at any suitable point of attachment. In some embodiments, aryl groups contain between 5 and 30 carbon atoms. In some embodiments, aryl groups contain one aromatic or heteroaromatic six-member ring and one or more additional five- or six-member aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents.

The term “arylalkyl” refers to an alkyl group substituted with one or more aryl groups wherein the alkyl groups optionally carry additional substituents and the aryl groups are optionally substituted. Specific arylalkyl groups are phenyl-substituted alkyl groups, e.g., phenylmethyl groups. The term “alkylaryl” refers to an aryl group substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms.

The term “alkylene” refers to a divalent group “—CH₂—” derived from an alkyl group as defined herein. The disclosure includes compounds having one or more alkylene groups. Alkylene groups in some compounds function as attaching and/or spacer groups. Compounds of the disclosure may have substituted and/or unsubstituted C₁-C₂₀ alkylene, C₁-C₁₀ alkylene and C₁-C₆ alkylene groups.

The term “cycloalkylene” refers to a divalent group derived from a cycloalkyl group as defined herein. The disclosure includes compounds having one or more cycloalkylene groups. Cycloalkyl groups in some compounds function as attaching and/or spacer groups. Compounds of the disclosure may have substituted and/or unsubstituted C₃-C₂₀ cycloalkylene, C₃-C₁₀ cycloalkylene and C₃-C₅ cycloalkylene groups.

The term “arylene” refers to a divalent group derived from an aryl group as defined herein. The disclosure includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as attaching and/or spacer groups. Arylene groups in some compounds function as chromophore, fluorophore, aromatic antenna, dye and/or imaging groups. Compounds of the disclosure include substituted and/or unsubstituted C₅-C₃₀ arylene, C₅-C₂₀ arylene, C₅-C₁₀ arylene and C₆-C₈ arylene groups.

The term “alkenylene” refers to a divalent group derived from an alkenyl group as defined herein. The disclosure includes compounds having one or more alkenylene groups. Alkenylene groups in some compounds function as attaching and/or spacer groups. Compounds of the disclosure include substituted and/or unsubstituted C₂-C₂₀ alkenylene, C₂-C₁₀ alkenylene and C₂-C₅ alkenylene groups.

The term “cycloalkenylene” refers to a divalent group derived from a cycloalkenyl group as defined herein. The disclosure includes compounds having one or more cycloalkenylene groups. Cycloalkenylene groups in some compounds function as attaching and/or spacer groups. Compounds of the disclosure include substituted and/or unsubstituted C₃-C₂₀ cycloalkenylene, C₃-C₁₀ cycloalkenylene and C₃-C₅ cycloalkenylene groups.

The term “alkynylene” refers to a divalent group derived from an alkynyl group as defined herein. The disclosure includes compounds having one or more alkynylene groups. Alkynylene groups in some compounds function as attaching and/or spacer groups. Compounds of the disclosure include substituted and/or unsubstituted C₂-C₂₀ alkynylene, C₂-C₁₀ alkynylene and C₂-C₅ alkynylene groups.

The terms “halo” and “halogen” can be used interchangeably and refer to a halogen group such as a fluoro (—F), chloro (—Cl), bromo (—Br) or iodo (—I)

The term “cycloaliphatic” (or “non-aromatic carbocyclic”) refers to a cyclic hydrocarbon that is completely saturated or that contains one or more units of unsaturation but which is not aromatic, and which has a single point of attachment to the rest of the molecule. Unless otherwise specified, a cycloaliphatic group may be monocyclic, bicyclic, tricyclic, fused, spiro, or bridged. In one embodiment, the term “cycloaliphatic” refers to a monocyclic C₃-C₁₂ hydrocarbon or a bicyclic C₇-C₁₂ hydrocarbon. In some embodiments, any individual ring in a bicyclic or tricyclic ring system has 3-7 members. Suitable cycloaliphatic groups include, but are not limited to, cycloalkyl, cycloalkenyl, and cycloalkynyl. Examples of aliphatic groups include cyclopropyl, cyclobutyl, cyclopentyl, cyclopentenyl, cyclohexyl, cyclohexenyl, cycloheptyl, cycloheptenyl, norbornyl, cyclooctyl, cyclononyl, cyclodecyl, cycloundecyl, cyclododecyl, and the like. The term “cycloaliphatic” also includes polycyclic ring systems in which the non-aromatic carbocyclic ring can be “fused” to one or more aromatic or non-aromatic carbocyclic or heterocyclic rings or combinations thereof, as long as the radical or point of attachment is on the non-aromatic carbocyclic ring.

The term “heteroalkyl” refers to an alkyl, alkenyl or alkynyl group as defined herein, wherein at least one carbon atom of the alkyl group is replaced with a heteroatom. In some instances, heteroalkyl groups may contain from 1 to 18 non-hydrogen atoms (carbon and heteroatoms) in the chain, or from 1 to 12 non-hydrogen atoms, or from 1 to 6 non-hydrogen atoms, or from 1 to 4 non-hydrogen atoms. Heteroalkyl groups may be straight or branched, and saturated or unsaturated. Unsaturated heteroalkyl groups have one or more double bonds and/or one or more triple bonds. Heteroalkyl groups may be unsubstituted or substituted. Exemplary heteroalkyl groups include, but are not limited to, alkoxyalkyl (e.g., methoxymethyl), and aminoalkyl (e.g., alkylaminoalkyl and dialkylaminoalkyl). Heteroalkyl groups may be optionally substituted with one or more substituents.

The term “fused ring” or “fused ring structure” refers to a plurality of alicyclic and/or aromatic rings provided in a fused ring configuration, such as fused rings that share at least two intra ring carbon atoms and/or heteroatoms.

The term “hydroxyalkyl” refers to a mono- or polyhydroxylated, for example the monohydroxylated, analogs of the above alkyl radicals, for example the linear hydroxyalkyl groups, for example those having a primary (terminal) hydroxyl group, such as hydroxymethyl, 2-hydroxyethyl, 3-hydroxypropyl, 4-hydroxybutyl, or those having nonterminal hydroxyl groups, such as 1-hydroxyethyl, 1- or 2-hydroxypropyl, 1 or 2-hydroxybutyl or 1-, 2- or 3-hydroxybutyl.

As used herein, the term “polyalkoxyalkyl” refers to a substituent of the formula alkyl-(alkoxy)ₙ-alkoxy wherein n is an integer from 1 to 10, e.g., 1 to 4, and in some embodiments 1 to 3.

The term “carbonyl”, as used herein, for example in the context of C₁₋₁₂ carbonyl substituents, generally refers to a carbon chain of given length (e.g., C₁₋₁₂), wherein each of the carbon atom of a given carbon chain can form the carbonyl bond, as long as it chemically feasible in terms of the valence state of that carbon atom. Thus, in some instances, the “C₁₋₁₂ carbonyl” substituent refers to a carbon chain of between 1 and 12 carbon atoms, and either the terminal carbon contains the carbonyl functionality, or an inner carbon contains the carbonyl functionality, in which case the substituent could be described as a ketone. The term “carboxyl”, as used herein, for example in the context of C₁₋₁₂ carboxyl substituents, generally refers to a carbon chain of given length (e.g., C₁₋₁₂), wherein a terminal carbon contains the carboxyl functionality, unless otherwise defined herein.

As to any of the groups described herein that contain one or more substituents, it is understood that such groups do not contain any substitution or substitution patterns which are sterically impractical and/or synthetically non-feasible. In addition, the compounds of this disclosure include all stereochemical isomers arising from the substitution of these compounds.

Unless otherwise defined herein, optional substituents for any alkyl, alkenyl and aryl group includes substitution with one or more of the following substituents, among others:
halogen, including fluorine, chlorine, bromine or iodine;
pseudohalides, including —CN, —OCN (cyanate), —NCO (isocyanate), —SCN (thiocyanate) and —NCS (isothiocyanate);
—COOR, where R is a hydrogen or an alkyl group or an aryl group and more specifically where R is a methyl, ethyl, propyl, butyl, or phenyl group all of which groups are optionally substituted;
—COR, where R is a hydrogen or an alkyl group or an aryl group and more specifically where R is a methyl, ethyl, propyl, butyl, or phenyl group all of which groups are optionally substituted;
—CON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂, where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring that can contain one or more double bonds and can contain one or more additional carbon atoms;
—SR, where R is hydrogen or an alkyl group or an aryl group and more specifically where R is hydrogen, methyl, ethyl, propyl, butyl, or a phenyl group, which are optionally substituted;
—SO₂R, or —SOR, where R is an alkyl group or an aryl group and more specifically where R is a methyl, ethyl, propyl, butyl, or phenyl group, all of which are optionally substituted;
—OCOOR, where R is an alkyl group or an aryl group;
—SO₂N(R)₂, where each R, independently of each other R, is a hydrogen, or an alkyl group, or an aryl group all of which are optionally substituted and wherein R and R can form a ring that can contain one or more double bonds and can contain one or more additional carbon atoms; and
—OR, where R is H, an alkyl group, an aryl group, or an acyl group all of which are optionally substituted. In a particular example R can be an acyl yielding —OCOR″, wherein R″ is a hydrogen or an alkyl group or an aryl group and more specifically where R″ is methyl, ethyl, propyl, butyl, or phenyl groups all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups that contain one or more substituents, it is understood that such groups do not contain any substitution or substitution patterns which are sterically impractical and/or synthetically non-feasible. In addition, the compounds of this disclosure include all stereochemical isomers arising from the substitution of these compounds.

### II. Recovery of Hydroxyl-Containing Compounds from Side Chain Groups of 3D Printed Crosslinked Polymeric Materials

In one aspect, the present disclosure provides methods for recovering hydroxyl-containing compounds, such as phenol derivatives and cycloaliphatic alcohol derivatives, from 3D printed crosslinked polymeric materials. These crosslinked polymeric materials contain repeating units with ester pendant groups derived from the hydroxyl-containing compounds, which can be recovered by a transesterification reaction. The crosslinked polymeric materials from which such hydroxyl-containing compounds are recovered can be part of a 3D printed object, such as a medical device (e.g., an orthodontic appliance).

Following recovery and purification, the hydroxyl-containing compound can be synthetically converted into monomers for reuse in the fabrication of 3D printed objects. This approach significantly reduces the costs, resource consumption, and energy demands associated with producing such crosslinked polymeric materials for various device applications, including medical devices such as orthodontic appliances.

The methods disclosed herein enable recovery of phenol derivatives (e.g., syringol and guaiacol) or cycloaliphatic alcohol derivatives (e.g., isoborneol and adamantanol) from the polymer network by transesterifying their corresponding phenolic or cycloaliphatic ester pendant groups, while preserving the polymer network. As a result, the polymer residue can be readily removed, for example, by filtration or centrifugation, thereby simplifying the recovery process.

In various embodiments, the hydroxyl-containing compound recovered herein is attached to a backbone of the crosslinked polymeric material as a pendant group (i.e., a side chain group) via an ester linkage. In such cases, methods are provided for recovering a hydroxyl-containing compound, such as a phenol derivative or a cycloaliphatic alcohol derivative, from a crosslinked polymeric material having corresponding phenolic ester or cycloaliphatic ester pendant groups. The recovery method involves replacing the phenolic ester or cycloaliphatic ester pendant groups with a transesterification agent through a transesterification reaction.

Further provided herein are methods for reusing the recovered hydroxyl-containing compounds, e.g., phenol or cycloaliphatic alcohol derivatives, by reacting such hydroxyl-containing compounds with a polymerizable functional group to obtain new monomers for the fabrication of new 3D printed objects, including medical devices such as orthodontic appliances.

### A. Ester Pendant Groups

In embodiments of the present discourse, a hydroxyl-containing compound that can be recovered from ester pendant groups (also referred to as “recovered hydroxyl-containing compound”) in a 3D printed crosslinked polymeric material of the present disclosure is a compound according to formula (A):

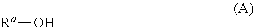

wherein R^{a} is substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl.

In embodiments of the present disclosure, a recovered hydroxyl-containing compound of formula (A) may include a phenol derivative or a cycloaliphatic alcohol derivative.

In some embodiments, a recovered hydroxyl-containing compound of the present disclosure is a phenol derivative of formula (I):

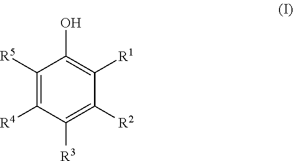

wherein R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo-(C₃₋₁₈) alkyl, substituted or unsubstituted cyclo(C₃₋₁₈) heteroalkyl, substituted or unsubstituted aryl, or substituted or unsubstituted heteroaryl.

In some embodiments, R¹, R⁵, or both are methoxy.

In some embodiments, R², R⁴, or both are independently H, methyl, ethyl, propyl, or butyl.

In some embodiments, R³ is H, methyl, ethyl, propyl, butyl, hydroxypropyl, hydroxy butyl, propenyl, butenyl, hydroxypropenyl, or hydroxybutenyl.

In some embodiments, R², R³, and R⁴ are H, and the phenol derivative is a compound of formula (Ia):

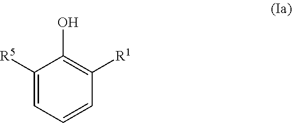

wherein,
R¹ and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl, but not simultaneously H.

In some embodiments, R¹ and R⁵ are each independently H or substituted or unsubstituted C₁₋₆ alkoxy. In some embodiments, R¹ and R⁵ are both methoxy, or R¹ is H and R⁵ is methoxy.

In some embodiments, the phenol derivative of formula (I) has one of the following structures:

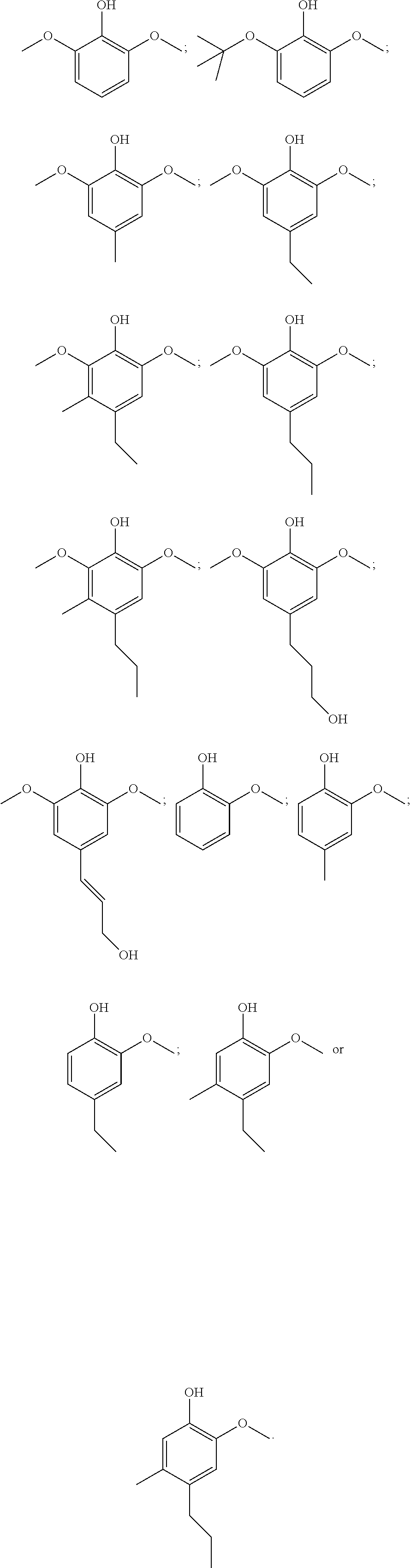

In some embodiments, the phenol derivative of formula (Ia) has one of the following structures:

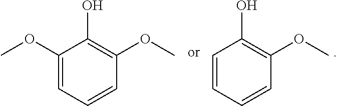

Before recovery, the phenol derivative of formula (I) is coupled to a backbone of the crosslinked polymeric material as a pendant group via an ester linkage. In some embodiments, the phenolic ester pendant group contained in the repeating units of the crosslinked polymeric material of the present disclosure that is derived from the phenol derivative of formula (I) has the following formula (II) (where “ [symbol] ” denotes the point of attachment to the polymer backbone):

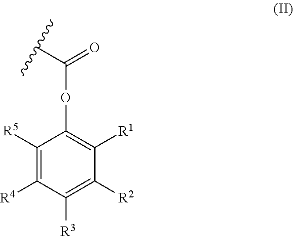

wherein R¹, R², R³, R⁴, and R⁵ are the same as in formula (I).

Hence, in some instances, the phenolic ester pendant group to be displaced with an alkoxide has one of the following structures (where “ [symbol] ” denotes the point of attachment to the polymer backbone):

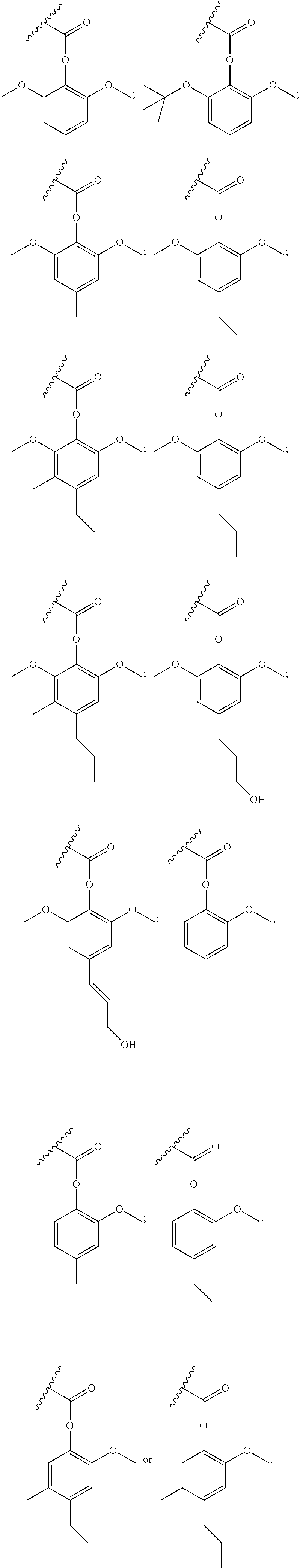

In some embodiments, R², R³, and R⁴ are H, and the phenolic ester pendant group of formula (II) has the following formula (IIa):

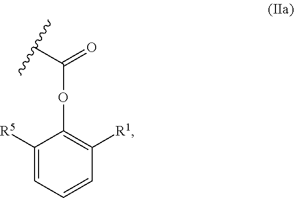

In some embodiments, R¹ and R⁵ are each independently H or substituted or unsubstituted C₁₋₆ alkoxy. In some embodiments, R¹ and R⁵ are both methoxy, or R¹ is H and R⁵ is methoxy.

In some embodiments, the phenolic ester pendant group of formula (IIa) has one of the following structures:

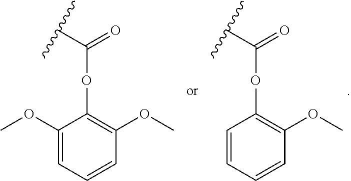

In some embodiments, a recovered hydroxyl-containing compound of the present disclosure is a cycloaliphatic alcohol derivative of formula (III):

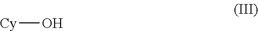

wherein Cy is substituted or unsubstituted cyclo(C₃₋₁₈) alkyl.

In some embodiments, the cylco(C₃₋₁₈) alkyl is monocyclic or polycyclic alkyl such as substituted or unsubstituted adamantyl, cyclohexyl, cycloheptyl, cyclooctyl, norbornyl, tricyclodecyl or tetracyclododecyl.

In some embodiments, Cy is substituted or unsubstituted and has one of the following structures:

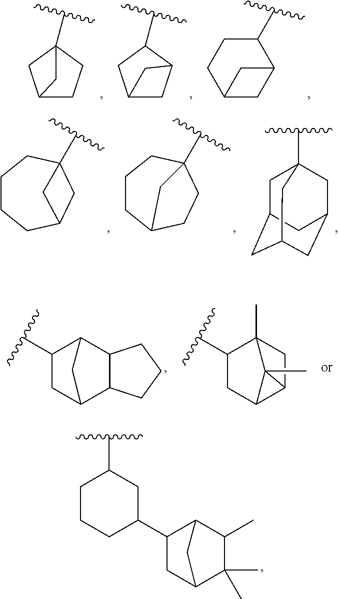

wherein [symbol] denotes the point of attachment to the remainder of formula (III).

In some embodiments, the cycloaliphatic alcohol derivative of formula (III) has one of the following structures:

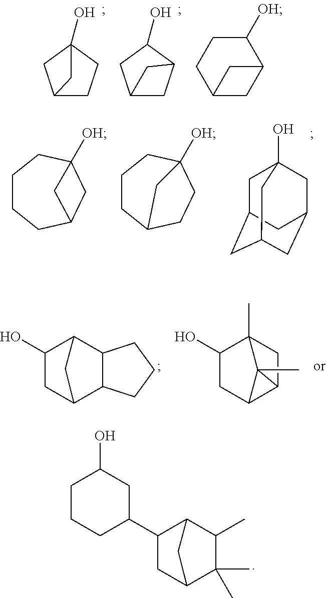

Before recovery, the cycloaliphatic alcohol derivative of formula (III) is coupled to a backbone of the crosslinked polymeric material as a pendant group via an ester linkage. In some embodiments, the cycloaliphatic ester pendant group of the present disclosure that is derived from the cycloaliphatic alcohol derivative of formula (III) has the following formula (IV) (where “ [symbol] ” denotes the point of attachment to the polymer backbone):

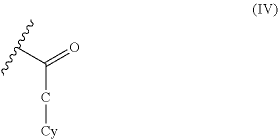

wherein Cy is the same as in formula (III).

Hence, in some instances, the cycloaliphatic ester pendant group to be displaced with an alkoxide has one of the following structures (where “ [symbol] ” denotes the point of attachment to the polymer backbone):

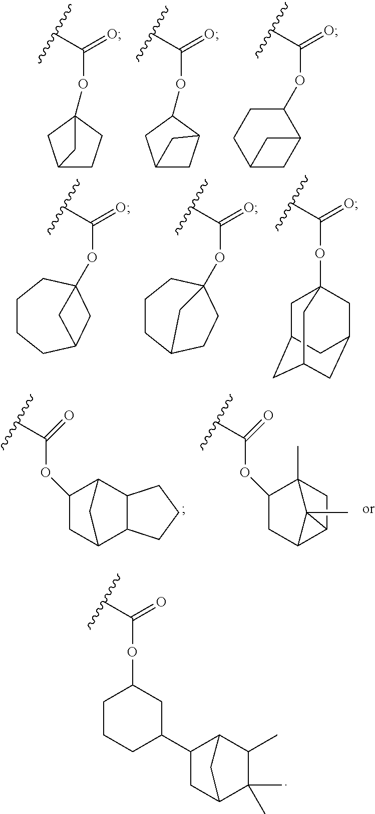

B. Methods of Recovering Hydroxyl-Containing Compounds from 3D Printed Crosslinked Polymeric Materials

The present disclosure provides methods for the recovery and reuse of hydroxyl-containing compounds of formula (A), including phenol derivatives of formula (I) or cycloaliphatic alcohol derivatives of formula (III), from a 3D printed crosslinked polymeric material comprising repeating units with corresponding ester pendant groups (e.g., phenolic ester pendant groups or cycloaliphatic ester pendant groups). In various embodiments, provided herein are methods for the recovery and/or reuse of hydroxyl-containing compounds of formula (A), for example, phenol derivatives of formula (I) or cycloaliphatic alcohol derivatives of formula (III), from a crosslinked polymeric material comprising repeating units with corresponding ester pendant groups, such as phenolic ester pendant groups of formula (II) or cycloaliphatic ester pendant groups of formula (IV), from a 3D printed object feedstock composed of such crosslinked polymeric material. In various instances, the 3D printed object feedstock from which a phenol derivative of formula (I) or a cycloaliphatic alcohol derivative of formula (III) is recovered can be waste or discarded materials generated during fabrication of the 3D printed object or post-consumer recovered materials obtained from the 3D printed object. In some embodiments, the 3D printed object may be a medical device. The medical device can be an orthodontic appliance (e.g., aligner, palatal expander, attachment, attachment template, retainer), a restorative object (e.g., crown, veneer, implant), and/or any other dental appliance (e.g., oral sleep apnea appliance, mouth guard).

Upon recovery and purification, the hydroxyl-containing compound of formula (A), including the phenol derivative of formula (I) or the cycloaliphatic alcohol derivative of formula (III), may be reintroduced into a synthetic framework to produce monomers, oligomers, and/or polymers from the recovered hydroxyl-containing compound, including the phenol derivative of formula (I) or the cycloaliphatic alcohol derivative of formula (III).

In some embodiments, provided herein is a method of recovering a hydroxyl-containing compound of formula (A), including a phenol derivative of formula (I) or a cycloaliphatic alcohol derivative of formula (III), from a 3D printed polymeric material. The method comprising: (i) providing a 3D printed object feedstock composed of a crosslinked polymeric material having repeating units that include ester pendant groups derived from the hydroxyl-containing compound, such as a phenolic ester pendant group of formula (II) or a cycloaliphatic ester pendant group of formula (IV); (ii) transesterifying the ester pendant group with a transesterification agent, optionally in the presence of a transesterification catalyst, thereby replacing the hydroxy-derived moiety originated from the hydroxyl-containing compound with an organic group of the transesterification agent to produce a mixture comprising the hydroxyl-containing compound, including the phenol derivative of formula (I) or the cycloaliphatic alcohol derivative of formula (III); and (iii) recovering the hydroxyl-containing compound from the mixture.

In some embodiments, prior to the transesterification reaction, the 3D printed object may be shredded or pulverized, and the resulting material may be used as-is without the need for cleaning. In some embodiments, the 3D printed object may be subjected to one or more preparatory processes, including pre-washing, coarse-cutting, wet and/or dry grinding, solvent washing, and clean water washing. The 3D printed object feedstock may be in the form of pellets, granular powders, or particles. In some embodiments, the 3D printed object feedstock may be in the form of particles having an average size less than 10,000 μm, 9,000 μm, 8,000 μm, 7,000 μm, 6,000 μm, 5,000 μm, 4,000 μm, 3,000 μm, 1,000 μm, 400 μm, or 100 μm. In some embodiments, the average size of the particles is in the range from 50 to 10,000 μm, for example, from 50 to 15.00 μm, from 70 to 1,200 μm, from 400 to 1,000 μm, or from 1,000 to 3,000 μm. In some embodiments, the average size of the particles is from 70 μm to 1,200 μm, although particles outside this range are also contemplated. In some embodiments, the size of the particles is from 100 μm to 1,000 μm, from 100 μm to 800 μm, or from 200 μm to 600 μm.

Further provided herein are methods for recovering a hydroxyl-containing compound, such as a phenol derivative of formula (I) or a cycloaliphatic alcohol derivative of formula (III), from a crosslinked polymeric material. In some embodiments, the method includes (i) providing a curable composition; (ii) curing the curable composition to generate a crosslinked polymeric material comprising repeating units that include ester pendant groups derived from a hydroxyl-containing compound, such as phenolic ester pendant groups of formula (II) or cycloaliphatic ester pendant groups of formula (IV); and (iii) subjecting the crosslinked polymeric material to a transesterification agent, optionally in the presence of a transesterification catalyst, to replace the hydroxyl-containing compound-derived ester pendant group with an organic group of the transesterification agent; and (iv) generating a mixture comprising the hydroxyl-containing compound, including the phenol derivative of formula (I) or the cycloaliphatic alcohol derivative of formula (III).

In this process, the crosslinked polymeric material produced in step (ii) is used in downstream processing to fabricate a medical device such as an orthodontic appliance. A portion (e.g., about 1%, 2%, 3%, 5%, or 10%) of the cured composition or the crosslinked polymeric material that is not used for further processing my instead undergo step (iii) to recover various components from the crosslinked polymeric material, including phenol derivatives of formula (I) or cycloaliphatic alcohol derivatives of formula (III), as described herein. Accordingly, the present disclosure allows the reduction of waste generated during various device fabrication processes by recovering and reusing at least a portion of the material that would otherwise be discarded as waste.

In some embodiments, the mixture may comprise, in addition to the hydroxyl-containing compound of formula (A) (e.g., a phenol derivative of formula (I) or a cycloaliphatic alcohol derivative of formula (III)), one or more impurities. Such impurities are generally defined as any molecules, excluding solvent, that are not derived from the pendant hydroxyl-containing compound-derived ester group. The impurities may include side products and/or decomposition products produced during the transesterification reaction. In certain instances, the mixture may contain impurities in an amount of up to about 10%, 5%, 3%, 2%, or 1% by weight based on dry solids.

In some embodiments, the method for recovering a hydroxyl-containing compound of formula (A), including a phenol derivative of formula (I) or a cycloaliphatic alcohol derivative of formula (III), from a crosslinked polymeric material, may further comprise distilling the mixture. Such distilling can produce a fraction comprising a crude hydroxyl-containing compound, such as a phenol derivative or cycloaliphatic alcohol. Such fraction can comprise the crude phenol derivative or cycloaliphatic alcohol in an amount from about 20% w/w to about 90% w/w, from about 30% w/w to about 80% w/w, from about 40% w/w to about 70% w/w, or from about 50% w/w to about 60% w/w based on dry solids. In various instances, the distilling comprises steam-distillation.

The crude (e.g., distilled) recovered compound, such as a crude phenol derivative or a crude cycloaliphatic alcohol as described herein, may be further purified using the methods described herein. In some embodiments, purification of a crude phenol derivative or a crude cycloaliphatic alcohol disclosed herein may comprise using a chromatographic separation system. Such a chromatographic separation system can include one or more exchange resins arranged in one or more separate columns. This purification step can yield a fraction comprising the recovered hydroxyl-containing compound, for example, a phenol derivative of formula (I) or a cycloaliphatic alcohol derivative of formula (III), with high purity, such as at least about 85%, 90%, 92%, or 94% pure, or very high purity, at least about 96%, 98%, or 99% pure. Purity can be expressed as a percentage by weight based on dry solids or as a percentage purity determined by analytical techniques such as liquid or gas chromatography. In various embodiments, the purified pendant group can achieve a purity of at least about 85%, 90%, 92%, 94%, 96%, 98%, or 99% pure based on the weight of total dry solids present following the evaporation of the solvent/eluent.

In some embodiments, the methods of the present disclosure provide for a recovery yield of at least about 20%, 30%, 40%, 45%, 50%, 55%, 60%, 65%, 70%, 75%, 80%, 85%, 90%, or at least about 95% of the phenol derivative to be recovered from a material herein. In various embodiments, the material is a crosslinked polymeric material (e.g., one that is part of a medical device). In such instances, at least about 20%, 30%, 40%, 45%, 50%, 55%, 60%, 65%, 70%, 75%, 80%, 85%, 90%, or at least about 95% of a phenol derivative can be recovered based on the amount of phenolic ester pendant groups of formula (II) or cycloaliphatic ester pendant groups of formula (IV) present in the crosslinked polymeric material prior to the recovery.

In some embodiments, a crosslinked polymeric material of the present disclosure from which a phenol derivative of formula (I) can be recovered comprises a monomeric unit of formula (V):

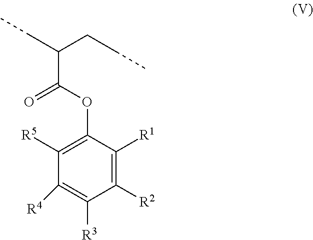

wherein:
[symbol] represents a segment of a backbone of the crosslinked polymeric material; and
R¹, R², R³, R⁴, and R⁵ are each independently H, substituted or unsubstituted C₁₋₁₂ alkyl, substituted or unsubstituted C₁₋₂₃ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl.

In some embodiments, the monomeric unit of formula (V) of the crosslinked polymeric material has one of the following structures:

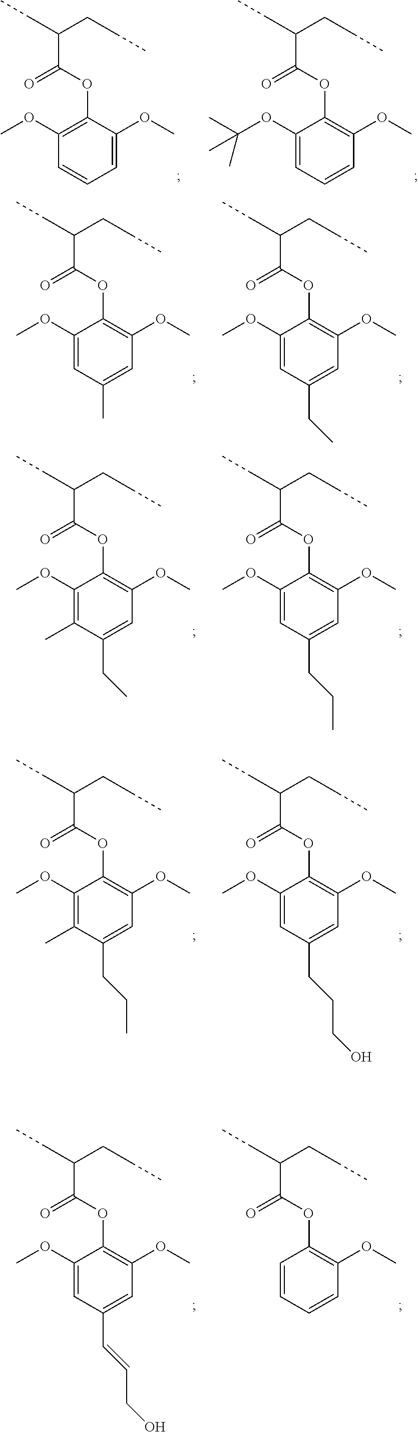

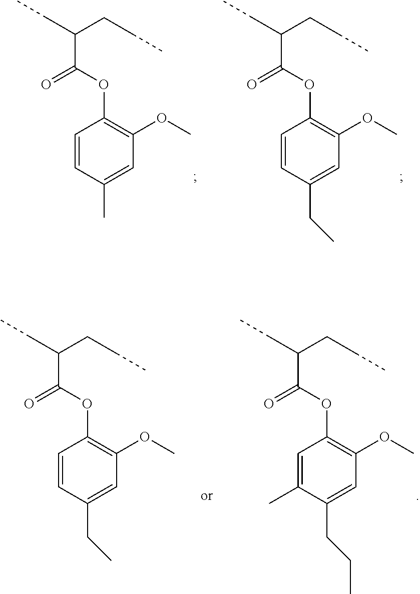

In certain embodiments, the monomeric unit of formula (V) of the crosslinked polymeric material has one of the following structures:

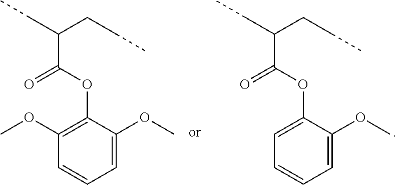

In some embodiments, a crosslinked polymeric material of the present disclosure from which a cycloaliphatic alcohol derivative of formula (III) can be recovered comprises a monomeric unit comprises a monomeric unit of formula (VI):

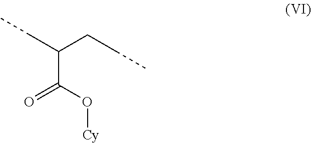

wherein:
[symbol] represents a segment of a backbone of the crosslinked polymeric material; and
Cy is substituted or unsubstituted cyclo(C₃₋₁₈) alkyl.

In some embodiments, the monomeric unit of formula (VI) of the crosslinked polymeric material has one of the following structures:

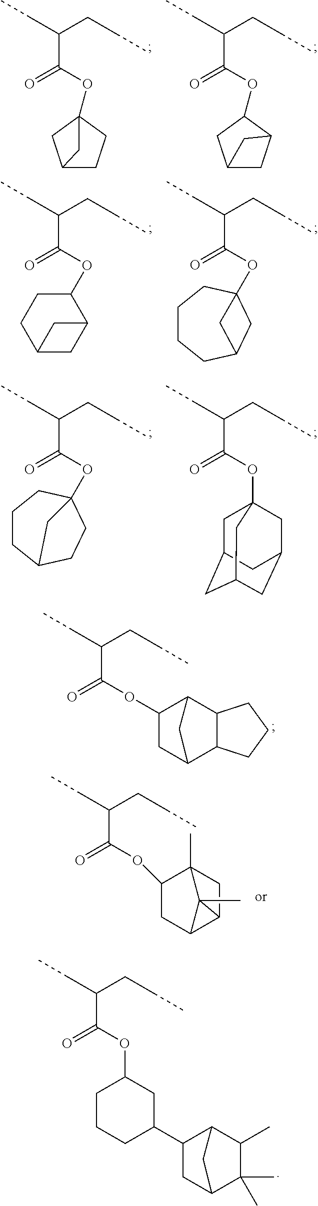

In some embodiments, the crosslinked polymeric material has a crosslinking density ranging from 0.00001 to 0.01 mol/g.

In some embodiments, the transesterification agent is an alcohol. In such instances, the phenol derivative of formula (I) may be recovered by transesterifying the phenolic ester pendant group in the monomeric unit of formula (V) of the crosslinked polymeric material, in the presence of a transesterification catalyst, with an alcohol according to SCHEME 1:

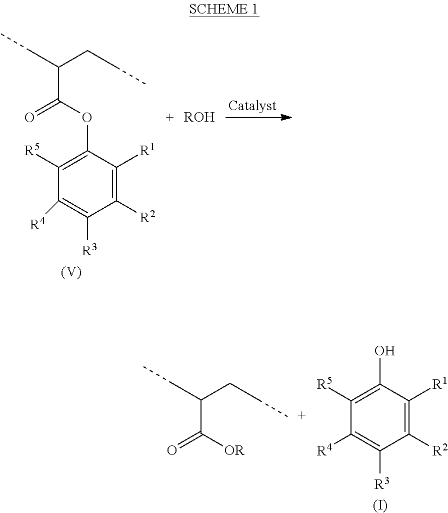

wherein:
R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl; and
R is substituted or unsubstituted C₁₋₂₀ alkyl, substituted or unsubstituted C₂₋₂₀ alkenyl, substituted or unsubstituted C₁₋₂₀ heteroalkyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl.

Similarly, the cycloaliphatic alcohol derivative of formula (III) may be recovered by transesterifying the cycloaliphatic ester pendant group in the monomeric unit of formula (VI) of the crosslinked polymeric material, in the presence of a transesterification catalyst, with an alcohol according to SCHEME 2:

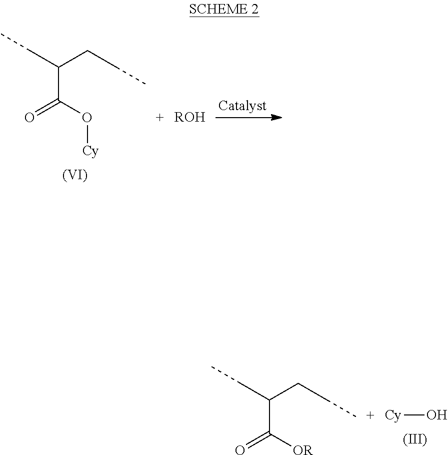

wherein:
Cy is substituted or unsubstituted cyclo(C₃₋₁₈) alkyl; and
R is substituted or unsubstituted C₁₋₂₀ alkyl, substituted or unsubstituted C₂₋₂₀ alkenyl, substituted or unsubstituted C₁₋₂₀ heteroalkyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl.

The alcohols for use in the transesterification reaction may be any primary and secondary alcohols, diols, triols, or tetraols. In some embodiments, the alcohols may include monoalcohols such as saturated aliphatic linear or branched monoalcohols having 1-20 carbon atoms, saturated aliphatic cyclic monoalcohols having 3 to 18 carbon atoms, unsaturated aliphatic monoalcohols having 3 to 20 carbon atoms, aromatic monoalcohols having 5 to 18 carbon atoms, alkoxyalcohols having 3 to 20 carbon atoms, glycols having 2 to 20 carbon atoms, and glycol ethers having 3 to 20 carbon atoms.

Exemplary saturated aliphatic monoalcohols include, but are not limited to, methanol, ethanol, n-propylalcohol, isopropylalcohol, n-butanol, isobutanol, tert-butylalcohol, 1-pentanol, 2-pentanol, 3-pentanol, 2-methyl-1-butanol, isopentylalcohol, sec-butylalcohol, tert-pentylalcohol, 3-methyl-2-butanol, neopentylalcohol, 1-hexanol, 2-methyl-1-pentanol, 4-methyl-2-pentanol, 2-ethyl-1-butanol, 1-heptanol, 2-heptanol, 3-heptanol, 1-octanol, 2-octanol, 2-ethyl-1-hexanol, 1-nonanol, 3,5,5-trimethyl-1-hexanol, 1-decanol, 1-undecanol, 1-dodecanol, 2-ethylhexyl alcohol, capryl alcohol, nonyl alcohol, decyl alcohol, undecyl alcohol, lauryl alcohol, tridecyl alcohol, myristyl alcohol, pentadecyl alcohol, cetyl alcohol, isocetyl alcohol, hexadecyl alcohol, heptadecyl alcohol, stearyl alcohol, oleyl alcohol, octyldodecyl alcohol, nonadecyl alcohol, eicosyl alcohol, ceryl alcohol, melissyl alcohol, α-terpineol, abietinol, and fusel oil. Exemplary cycloaliphatic alcohols include, but are not limited to, cyclopropanol, cyclobutanol, cyclopentanol, cyclohexanol, cycloheptanol, 1-methylcyclohexanol, 2-methylcyclohexanol, 3-methylcyclohexanol, and 4-methylcyclohexanol. Exemplary aromatic alcohols include, but are not limited to, benzyl alcohol, phenoxyethanol, and phenethyl alcohol. Exemplary unsaturated aliphatic monoalcohols include, but are not limited to, allyl alcohol, propargyl alcohol, methallyl alcohol, 2-butenyl alcohol, 3-butenyl alcohol, and 2-pentenyl alcohol. Exemplary alkoxyalcohols include, but are not limited to, methoxyethanol, 2-ethoxyethanol, 2-(2-methoxy)ethoxyethanol, 2-(2-butoxyethoxy)ethanol, 2-butoxyethanol, 2-propoxyethanol, 1-methoxy-2-propanol, 1-ethoxy-2-propanol, 3-methoxy-3-methyl-1-butanol, 2-(methoxymethoxy)ethanol, 2-isopropoxyethanol, 2-butoxyethanol, and 2-isopentyloxyethanol; Exemplary glycols include, but are not limited to, ethylene glycol, propylene glycol, butylene glycol, hexylene glycol, diethylene glycol, dipropylene glycol, trimethylene glycol, triethylene glycol, and tetraethylene glycol. Exemplary glycol ethers include, but are not limited to, ethylene glycol monomethyl ether, ethylene glycol monoethyl ether, ethylene glycol mono n-propyl ether, ethylene glycol mono n-butyl ether, ethylene glycol dimethyl ether, ethylene glycol diethyl ether, diethylene glycol monomethyl ether, diethylene glycol monoethyl ether, diethylene glycol monobutylether, diethylene glycol monohexyl ether, diethylene glycol dimethyl ether, diethylene glycol diethyl ether, triethylene glycol monomethyl ether, triethylene glycol monoethyl ether, propylene glycol monoethyl ether, dipropylene glycol monomethyl ether, dipropylene glycol monoethyl ether, and tripropylene glycol monomethyl ether.

In some embodiments, the alcohol is n-butanol, methoxy ethanol, or ethylene glycol.

The molar ratio of the 3D printed object feedstock to the alcohol may range from 1:1 to 1:9. In some embodiments, the molar ratio of the 3D printed object feedstock to the alcohol is 1:3, 1:4, 1:5, or 1:6.

The transesterification catalyst for use in the process is an inorganic catalyst, an organocatalyst, an organometallic catalyst, or a combination thereof. In some embodiments, the transesterification catalyst is present at a concentration of 0.1 molar equivalent (eq.) to 5 eq., 0.1 eq. to 4 eq., 0.1 eq. to 3 eq., 0.1 eq. to 2 eq., or 0.1 eq. to 1 eq., based on the dry solid weight of the 3D printed object feedstock.

In some embodiments, the transesterification catalyst is an inorganic catalyst including a metal oxide such as barium oxide, magnesium oxide, strontium oxide, or calcium oxide, an alkali carbonate such as potassium carbonate (K₂CO₃) or caesium carbonate (Cs₂CO₃), or an alkali hydrogen carbonate such as potassium hydrogen carbonate (KHCO₃).

In some embodiments, the transesterification catalyst is an organocatalyst including, but not limited to, 1,4-diazabicyclo[2.2.2]octane, triazobicyclodecene (TPD), triphenylphosphine (PPH₃), or 4-dimethylaminopyridine (DMAP).

In some embodiments, the transesterification catalyst is an organometallic catalyst including a zinc complex such as zinc acetate (Zn(OAc)₂), zinc acetylacetonate, zinc acetylacetonate hydrate, bis(2,6-dimethyl-3,5-heptanedionato) zinc, bis(2,2,6,6-tetramethyl-3,5-heptanedionato) zinc, or bis(5,5-dimethyl-2,4-hexanedionato) zinc; or a zirconium complex such as zirconium acetyl acetonate.

In some more specific embodiments, the transesterification catalyst used in the transesterification reaction according to SCHEME 1 is Zn(OAc)₂, TPD, PPH₃, DMAP, K₂CO₃, or KHCO₃.

In some embodiments, it is possible to perform the transesterification reaction without using a solvent when excess alcohol is employed. However, a solvent may be used in some embodiments. Exemplary solvents for use in the transesterification reaction according to SCHEME 1 include, but are not limited to, hydrocarbons such as n-hexane, cyclohexane, methylcyclohexane, n-heptane, n-octane, n-nonane, n-decane, benzene, toluene, xylene, ethylbenzene, diethylbenzene, isopropylbenzene, amylbenzene, diamylbenzene, triamylbenzene, dodecylbenzene, didodecylbenzene, amyltoluene, isopropyltoluene, decalin, or tetralin, ethers such as diethyl ether, dipropyl ether, diisopropyl ether, dibutyl ether, diamyl ether, diethylacetal, dihexyl acetal, t-butylmethyl ether, cyclopentyl methyl ether, tetrahydrofuran, tetrahydropyran, trioxane, dioxane, anisole, diphenyl ether, dimethyl cellosolve, diglyme, triglyme, or tetraglyme, crown ethers such as 18-crown-6, esters such as methyl benzoic acid or γ-butyrolactone, ketones such as acetone, methyl ethyl ketone, methyl isobutyl ketone, cyclohexanone, acetophenone, or benzophenone, sulfones such as sulfolane, sulfoxides such as dimethyl sulfoxide, ureas or derivatives thereof, phosphine oxides such as tributylphosphine oxide, ionic liquid such as imidazolium salt, piperidinium salt, or pyridinium salt, and silicone oil. These solvents may be used either singly or in combination of two or more types.

In a typical procedure for carrying out the transesterification reaction according to SCHEME 1 or SCHEME 2, the phenolic ester pendant group in the monomeric unit of formula (V) of the crosslinked polymeric material or the cycloaliphatic ester pendant group in the monomeric unit of formula (VI) of the crosslinked polymeric material is transesterified with an alcohol, in the presence of a transesterification catalyst, by heating the mixture at elevated temperatures, for example ranging from 150° C. to 300° C., and at reduced pressures, for example ranging from 40 psi to 400 psi. In some embodiments, the transesterification reaction is carried out in a Parr reactor at a temperature ranging from 245° C. to 250° C. at a pressure ranging from 40 to 400 psi, for example, from 50 to 60 psi, 240 to 260 psi, or from 330 to 360 psi. The transesterification reaction is continued until the phenolic ester groups in formula (V) or the cycloaliphatic ester groups in formula (VI) are significantly or completely displaced by the alcohol, for instance, from 1 to 18 hours. Following the transesterification reaction, the solid portion is removed by filtering or centrifuging, and the excess alcohol then is removed by rotary evaporation. The resulting crude oil is distilled under vacuum (1 mmHg) at an elevated temperature ranging from 120-150° C. to afford the phenol derivative of formula (I) or the cycloaliphatic alcohol derivative of formula (III). The resulting phenol or cycloaliphatic alcohol derivative can be recycled and used to synthesize components for curable resins.

In some embodiments, the transesterification agent comprises a metal alkoxide (M-OR′). In such instances, the phenol derivative of formula (I) may be recovered by transesterifying the phenolic ester pendant group in the monomeric unit of formula (V) of the crosslinked polymeric material with a metal alkoxide in a solvent according to SCHEME 3:

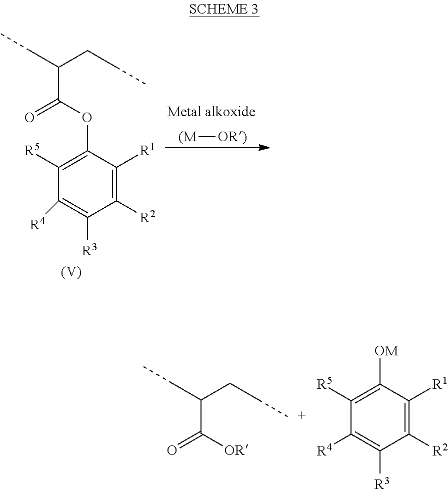

wherein:
R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl;
R′ is substituted or unsubstituted C₁₋₂₀ alkyl, substituted or unsubstituted C₁₋₂₀ hydroxy alkyl, substituted or unsubstituted C₂₋₂₀ alkenyl, substituted or unsubstituted C₂₋₂₀ hydroxyalkenyl, substituted or unsubstituted C₁₋₂₀ heteroalkyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl; and
M is an alkali metal, alkaline earth metal or transition metal element.

Similarly, the cycloaliphatic alcohol derivative of formula (III) may be recovered by transesterifying the cycloaliphatic ester pendant group in the monomeric unit of formula (VI) of the crosslinked polymeric material with a metal alkoxide in a solvent according to SCHEME 4:

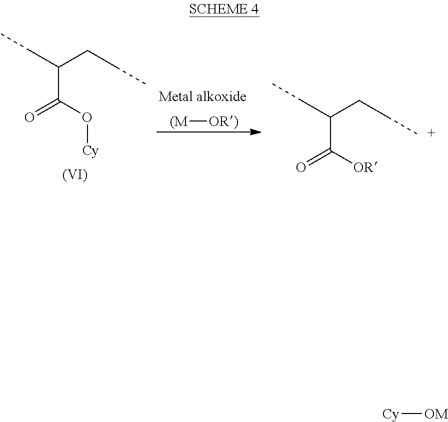

wherein:
Cy is substituted or unsubstituted cyclo(C₃₋₁₈) alkyl;
R′ is substituted or unsubstituted C₁₋₂₀ alkyl, substituted or unsubstituted C₁₋₂₀ hydroxy alkyl, substituted or unsubstituted C₂₋₂₀ alkenyl, substituted or unsubstituted C₂₋₂₀ hydroxyalkenyl, substituted or unsubstituted C₁₋₂₀ heteroalkyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl; and
M is an alkali metal, alkaline earth metal or transition metal element.

In some embodiments, the metal alkoxide for use in the process comprises an alkali metal alkoxide, an alkaline earth metal alkoxide, or a transition metal alkoxide. For example, in some embodiments, the metal in the metal alkoxide is selected from the group consisting of sodium, potassium, caesium, magnesium, calcium, aluminum, copper, nickel, tin, titanium, zinc, zirconium, gold, silver, platinum, cobalt, iron, ruthenium, and palladium. In some more specific embodiments, the metal is sodium.

In some embodiments, the alkoxide in the metal alkoxide is selected from the group consisting of methoxide, ethoxide, n-propoxide (nPr), isopropoxide (iPr), butoxide, 2-methylpropoxide, and tert-butoxide.

In some embodiments, the metal alkoxide is selected from the group consisting of sodium tert-butoxide, potassium tert-butoxide, titanium isopropoxide, aluminum ethoxide, aluminum isopropoxide, and zirconium ethoxide.

The metal oxide may be used alone or in combination with an inorganic base. Examples of inorganic bases include, but are not limited to, alkali metal carbonates such as caesium carbonate, potassium carbonate and sodium carbonate, alkali metal hydrides such as sodium hydride, and alkali metal hydroxides such as potassium hydroxide and sodium hydroxide. In some embodiments, the transesterification agent comprises a mixture of sodium tert-butoxide and potassium carbonate (K₂CO₃).

In some embodiments, the solvent for use in the process may include n-butanol, ethylene glycol, dimethylformamide (DMF), dioxane, 2-methyl tetrahydrofuran, cyclopentyl methyl ether (CPME), dimethyl sulfoxide, N-methyl-2-pyrrolidone, or a mixture thereof. In some embodiments, the solvent is a mixed solvent comprising a mixture of N-methyl-2-pyrrolidone and CPME. In some embodiments, the solvent may be a mixture of an organic solvent described above and water. In some embodiments, the amount of water in the mixture is no greater than 10%. In some embodiments, the solvent contains dimethyl sulfoxide and water.

In some embodiments, the transesterification reaction according to SCHEME 3 or SCHEME 4 includes adding a metal alkoxide into a mixture comprising a 3D printed object feedstock and a solvent, wherein an amount of the metal alkoxide added is from 1 molar equivalent (eq.) to 5 eq., 1 eq. to 4 eq., 1 eq. to 3 eq., 1 eq. to 2 eq, based on the dry solid weight of the 3D printed object feedstock. In some embodiments, the amount of the metal alkoxide added is about 2 eq. or 4 eq. of the 3D printed object feedstock.

In some embodiments, the transesterification reaction between the phenolic ester or cycloaliphatic ester pendant group and metal alkoxide is conducted at a reactor temperature ranging from about 80° C. to about 150° C. In one embodiment, the transesterification reaction is conducted at about 80° C., 100° C., or 120° C.

In some embodiments, the transesterification reaction between the phenolic ester or cycloaliphatic ester pendant group and the metal alkoxide is conducted for a time ranging from about 1 hour to about 24 hours. In one embodiment, the transesterification reaction is conducted for about 3 hours. In another embodiment, the transesterification reaction is conducted for about 18 hours

In some embodiments, following the transesterification reaction, excess metal alkoxide may be removed by washing with water. One or more washing steps may be used. During each washing step, a water phase and an organic phase may form. The organic phases may be neutralized and collected, and solvents may be removed by rotary evaporation. The resulting crude oil is distilled under vacuum (1 mmHg) at 120-150° C. to afford the phenol derivative of formula (I) or the cycloaliphatic alcohol derivative of formula (III). The phenol or cycloaliphatic alcohol derivative can be recovered, recycled, and used to synthesize components for curable resins.

C. Methods of Synthesizing Polymerizable Compounds from Recovered Hydroxyl-Containing Compounds

Further provided herein are methods for using a purified phenol or cycloaliphatic alcohol derivative recovered from a 3D printed crosslinked polymeric material to synthesize a polymerizable compound that can be used as a component in resins used for fabricating 3D printed objects, thereby recovering the phenol or cycloaliphatic alcohol derivative by reintroducing it into the materials cycle. Such a polymerizable compound generated from a recovered phenol derivative herein can be used for fabricating polymeric components and materials used in many different industries such as transportation (e.g., planes, trains, boats, automobiles, etc.), hobbyist, prototyping, medical, art and design, microfluidics, molds, among others.

In various embodiments, the phenol or cycloaliphatic alcohol derivative that is recovered is a pendant group contained in a crosslinked polymeric material as described herein. The recovered phenolic or cycloaliphatic alcohol pendant group can subsequently be purified for further downstream use. In various embodiments, a phenolic pendant group is derived from a phenol derivative according to formula (I), and a cycloaliphatic alcohol pendant group is derived from a cycloaliphatic alcohol derivative according to formula (III). In order to convert such phenol or cycloaliphatic alcohol derivative into a polymerizable compound, any functional group (FG) capable of undergoing a polymerization reaction can be coupled to such phenol or cycloaliphatic alcohol derivative by forming an ester bond. In some embodiments, the functional group (FG) can comprise one of the following moieties:

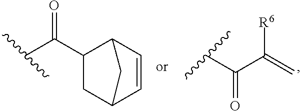

or any derivative thereof,
wherein:
“ [symbol] ” indicates the location at which the functional group is coupled to a pendant group; and
R⁶ is H, halogen, or substituted or unsubstituted C₁-C₃ alkyl.

In some embodiments, R⁶ is H or methyl.

Any suitable coupling chemistry known in the art may be used to couple a functional group to a phenol derivative of formula (I) or a cycloaliphatic alcohol derivative of formula (III) to produce a polymerizable compound. Such coupling reactions may include nucleophilic substitution. In some embodiments, a recovered phenol derivative of formula (I) can be modified with a functional group (FG) according to SCHEME 5:

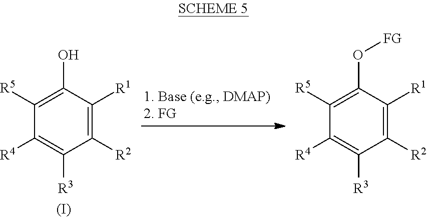

wherein:
FG is a functional group that can react with the phenol group of the phenol derivative of formula (I) by an esterification reaction; and
R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl.

In some embodiments, a recovered phenol derivative of formula (I) can be modified with a functional group comprising an acrylate or methacrylate to produce a monomer (e.g., a polymerizable compound) according to SCHEME 6:

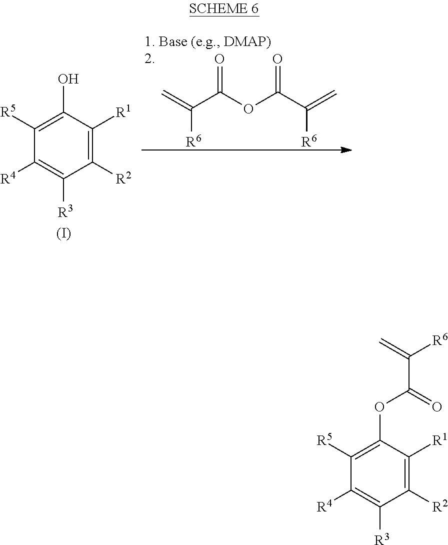

wherein:
R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl; and
R⁶ is H, halogen, or substituted or unsubstituted C₁₋₃ alkyl.

Hence, in some embodiments, a recovered phenol derivative herein can be used to synthesize a polymerizable compound of formula (VII):

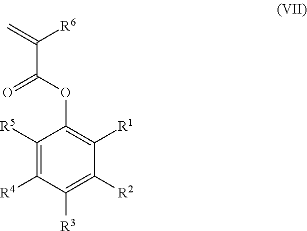

wherein:
R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo-(C₃₋₁₈) alkyl, substituted or unsubstituted cyclo(C₃₋₁₈) heteroalkyl, substituted or unsubstituted aryl, or substituted or unsubstituted heteroaryl; and
R⁶ is H, halogen, or substituted or unsubstituted C₁₋₃ alkyl.

In some embodiments, the polymerizable compound of formula (VII) has one of the following structures:

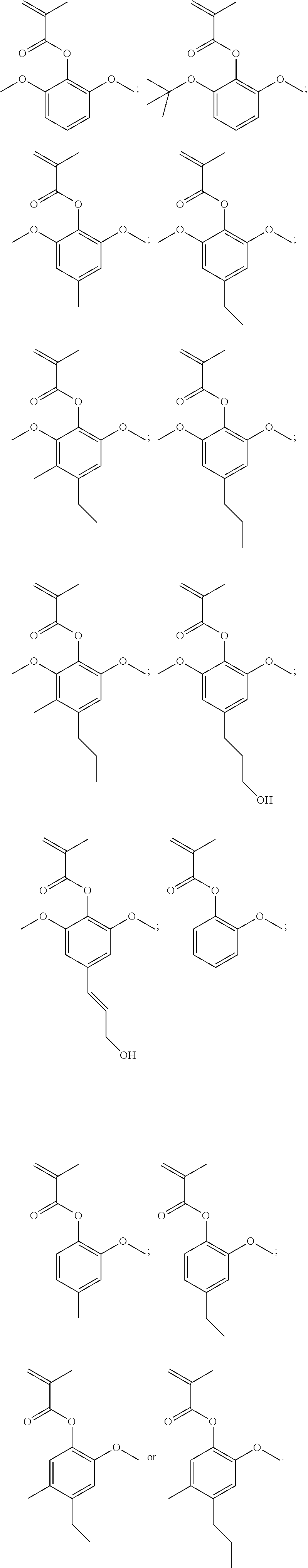

In certain embodiments, the polymerizable compound of formula (VII) has one of the following structures:

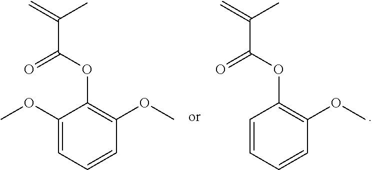

Similarly, in some embodiments, a recovered cycloaliphatic alcohol derivative of formula (III) can be modified with a functional group (FG) according to SCHEME 7:

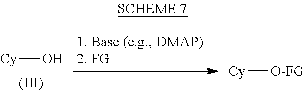

wherein:
FG can be any functional group that can react with the hydroxyl group of the cycloaliphatic alcohol derivative of formula (III) by an esterification reaction; and
Cy is substituted or unsubstituted cyclo(C₃₋₁₈) alkyl.

In some embodiments, a recovered cycloaliphatic alcohol derivative of formula (III) can be modified with a functional group comprising an acrylate or methacrylate to produce a monomer (e.g., a polymerizable compound) according to SCHEME 8:

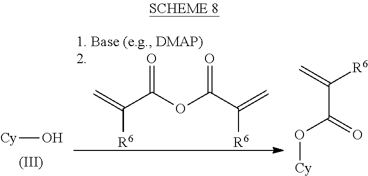

wherein:
Cy is substituted or unsubstituted cyclo(C₃₋₁₈) alkyl; and
R⁶ is H, halogen, or substituted or unsubstituted C₁₋₃ alkyl.

Hence, in some embodiments, a recovered cycloaliphatic alcohol derivative herein can be used to synthesize a polymerizable compound of formula (VIII):

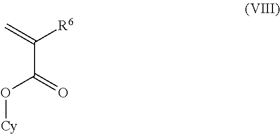

wherein:
Cy is substituted or unsubstituted cyclo(C₃₋₁₈) alkyl; and
R⁶ is H, halogen, or substituted or unsubstituted C₁₋₃ alkyl.

In some embodiments, the polymerizable compound of formula (VIII) has one of the following structures:

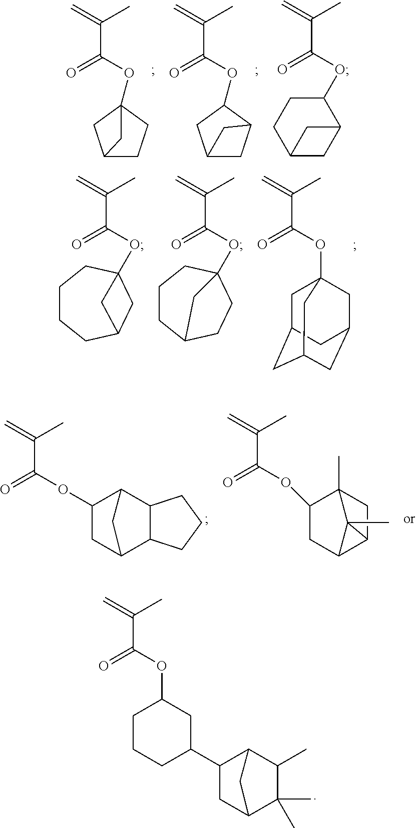

In some embodiments, any of such methods can comprise isolating the polymerizable compound comprising a pendant moiety with a chemical yield of at least about 25%, 30%, 40%, 50%, 60%, 70%, 80%, 90%, or at least about 95%, and a chemical purity of at least about 90%, 95%, or 99%. One of skill in the art may appreciate that protecting groups may be necessary for the preparation of certain compounds and may be aware of those conditions compatible with a selected protecting group.

Further provided herein is a method of polymerizing (e.g., photo-curing) a curable composition (e.g., a photo-curable resin) comprising at least one polymerizable compound synthesized from a recovered phenol derivative (e.g., one according to formula (VII)) or from a received cycloaliphatic alcohol derivative (e.g., one according to formula (VIII)). In such instances, a polymerizable compounds synthesized from a recovered phenol or cycloaliphatic alcohol derivative can be used to fabricate crosslinked polymeric materials used in devices, such as medical devices (e.g., orthodontic devices), by 3D printing. The crosslinked polymeric materials are biocompatible and/or bioinert.

### III. Recovery of (Meth)Acrylate Monomers from 3D Printed Crosslinked Polymeric Materials

In another aspect, the present disclosure provides methods for recovering (meth)acrylate monomers from 3D printed crosslinked polymeric materials comprising corresponding structural units. The 3D printed crosslinked polymeric materials from which such (meth)acrylate monomers are recovered can be part of a 3D printed object, such as a medical device (e.g., an orthodontic appliance). Following recovery and purification, the (met) acrylate monomers described herein can be reused in the fabrication of 3D printed objects, thereby significantly reducing costs, resources, and energy requirements associated with the fabrication of such 3D printed objects for various device applications (e.g., medical devices such as orthodontic appliances). The present disclosure enables the recovering of high-valued (meth)acrylate monomers, such as syringyl (meth)acrylate, through the thermal depolymerization of 3D printed crosslinked polymeric materials comprising corresponding structural units, with or without the use of a catalyst.

Further provided herein are methods for reusing the recovered (meth)acrylate monomers as reactive diluents in polymerizable compositions for the fabrication of new devices, such as orthodontic appliances.

### A. Reactive Diluent Monomers

In various embodiments, a reactive diluent monomer to be recovered from a crosslinked polymeric material (e.g., one that is part of a medical device or waste/discarded material generated during the fabrication of the medical device) using the herein disclosed methods can be a monofunctional (meth)acrylate monomer. In some embodiments, the (meth)acrylate monomer herein is a compound according to formula (B):

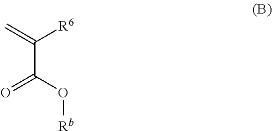

wherein:
R⁶ is H, halogen, or substituted or unsubstituted C₁₋₃ alkyl; and
R^{b} is substituted or unsubstituted C₁₋₁₂ alkyl, substituted or unsubstituted C₁₋₁₂ heteroalkyl, substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl.

In some embodiments, R⁶ is H or C₁-C₃ alkyl. In some embodiments, R⁶ is H or methyl.

In some embodiments, R^{b} is substituted or unsubstituted C₁₋₁₂ alkyl, substituted or unsubstituted cyclo(C₃₋₁₈) alkyl, or substituted or unsubstituted cyclo(C₃₋₁₈) heteroalkyl. In some embodiments, R^{b} is substituted or unsubstituted C₁₋₆ alkyl. In some embodiments, R^{b} is methyl, ethyl, propyl, n-butyl, t-butyl, iso-butyl, pentyl, or hexyl. In certain embodiments, the (meth)acrylate monomer has the following structure:

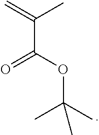

In some embodiments, R^{b} is substituted or unsubstituted cyclo(C₃₋₁₈) alkyl, substituted or unsubstituted cyclo(C₃₋₁₈) heteroalkyl, or substituted or unsubstituted C₁-12alkylene-cyclo(C₃₋₁₈) heteroalkyl. In some embodiments, R^{b} is substituted or unsubstituted cyclo(C₃₋₁₈) alkyl. In some embodiments, the cyclo(C₃₋₁₈) alkyl is bicyclic. In some embodiments, R^{b} is substituted or unsubstituted C₁₋₁₂ alkylene-cyclo(C₃₋₁₈) heteroalkyl. In certain embodiments, the monofunctional (meth)acrylate monomer has one of the following structures:

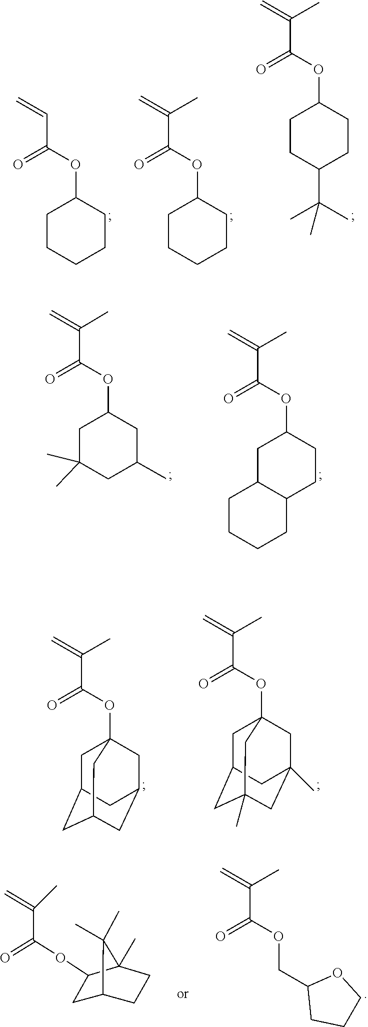

In some embodiments, R^{b} is substituted or unsubstituted aryl. In certain embodiments, the monofunctional (meth)acrylate monomer is a compound according to formula (IX):

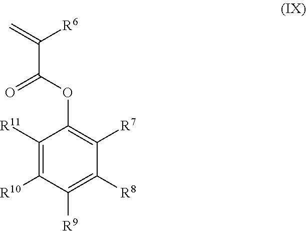

wherein:
R⁶ is H, substituted or unsubstituted C₁₋₃ alkyl, or halogen; and
R⁷, R⁸, R⁹, R¹⁰ and R¹¹ are each independently H, substituted or unsubstituted C₁₋₁₂ alkyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxy, substituted or unsubstituted cyclo(C₃₋₁₈) alkyl, substituted or unsubstituted cyclo(C₃₋₁₈) heteroalkyl, substituted or unsubstituted aryl, substituted or unsubstituted heteroaryl, or —Y—(CH₂)ₙ—R¹², or R¹⁰ and R¹¹ together form a 4-, 5-, 6-, 7-, or 8-membered ring selected from substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl;
wherein Y is O, S, NH, or C(O)O;
n is an integer from 0 to 6; and
R¹² is substituted or unsubstituted cyclo(C₃₋₁₈) alkyl, substituted or unsubstituted cyclo-(C₃₋₈) heteroalkyl, substituted or unsubstituted aryl, or substituted or unsubstituted heteroaryl.

In some embodiments, R⁶ is H or methyl.

In some embodiments, R⁷ is H or C₁₋₆ alkoxy. In some embodiments, R⁷ is methoxy.

In some embodiments, R⁸ is H.

In some embodiments, R⁹ is H, C₁₋₆ alkyl, C₁₋₆ alkoxy, or C₁₋₆ carbonyl. In some embodiments, R⁹ is methyl, ethyl, or C₁ carbonyl.

In some embodiments, R¹⁰ is H.

In some embodiments, R¹¹ is H, C₁₋₆ alkoxy, or aryl. In some embodiments, R¹¹ is methoxy or phenyl.

In some embodiments, the (meth)acrylate monomer has one of the following structures:

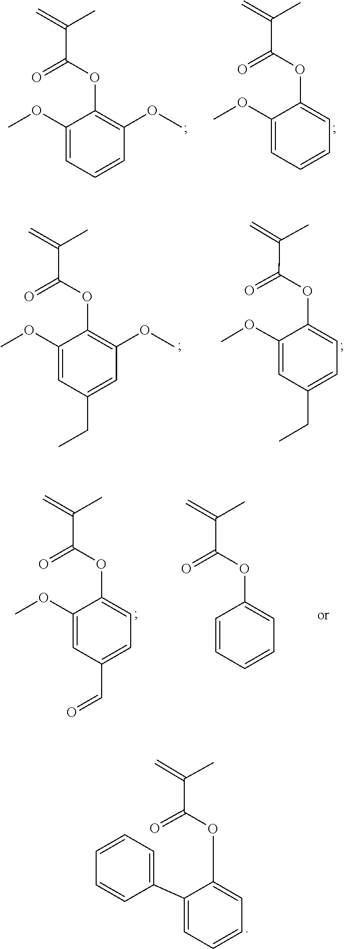

### B. Polymerizable Compositions

In various of embodiments, polymerizable compositions (also referred to as “curable resins”) from which the 3D printed crosslinked polymeric materials of the present disclosure are formed via 3D printing can include (i) one or more species of (meth)acrylate monomers of formula (B) described above as reactive diluents, (ii) one or more species of telechelic compounds as toughness modifiers, and (iii) a polymerization initiator.

In some embodiments, the telechelic compound can be a telechelic oligomer or a telechelic polymer. In some embodiments, the telechelic compound comprises an oligomeric or polymeric chain of interconnected monomeric units having at least one terminal reactive functional group coupled at each end. In some embodiments, the linear oligomeric or polymeric chain is selected from (poly)carbonate-(poly)urethane, (poly)ester-(poly)urethane, (poly)ether-(poly)urethane, (poly)thioether-(poly)urethane, hydrogenated (poly)butadiene, (poly)ester, (poly)ether, or (poly)urethane, and the terminal reactive functional group is selected from an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide, and a styrenyl. In some embodiments, the telechelic compound includes polyurethane di(meth)acrylate, polyester di(meth)acrylate, epoxy di(meth)acrylate, or polyamide di(meth)acrylate.

In some embodiments, the telechelic compound has is a compound according to formula (X):

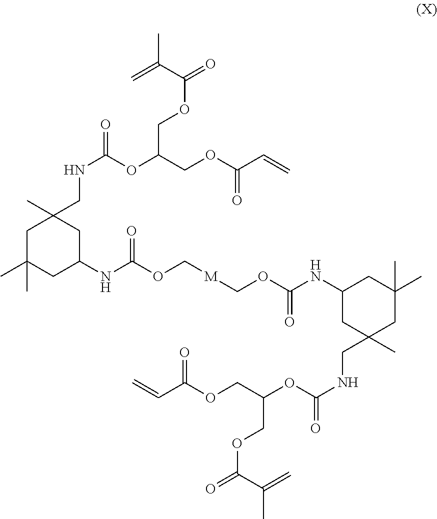

wherein M is an oligomeric or polymeric chain of (poly)carbonate-(poly)urethane, (poly)ester-(poly)urethane, (poly)ether-(poly)urethane, (poly)thioether-(poly)urethane, hydrogenated (poly)butadiene, (poly)ester, (poly)ether or (poly)urethane.

The polymerizable composition disclosed herein can be a photo-polymerizable composition. In some embodiments, the polymerization initiator is a photoinitiator. Such a photoinitiator, when activated with light of an appropriate wavelength (e.g., UV/VIS) can initiate a polymerization reaction (e.g., during photo-curing) between the reactive diluents, toughness modifiers, and other potentially polymerizable components that may be present in the photo-polymerizable composition, to form a 3D printed crosslinked polymeric material as further described herein. Generally, photoinitiators described in the present disclosure can include those that can be activated with light and initiate polymerization of the polymerizable components of the formulation. A “photoinitiator”, as used herein, may generally refer to a compound that can produce radical species and/or promote radical reactions upon exposure to radiation (e.g., UV or visible light).

In embodiments, the photoinitiator is a radical photoinitiator and/or a cationic initiator. In some embodiments, the photoinitiator is a Type I photoinitiator which undergoes a unimolecular bond cleavage to generate free radicals. In some embodiments, the photoinitiator is a Type II photoinitiator which undergoes a bimolecular reaction to generate free radicals. Common Type I photoinitiators include, but are not limited to, benzoin ethers, benzil ketals, α-dialkoxy-acetophenones, α-hydroxy-alkyl phenones, and acyl-phosphine oxides. Common Type II photoinitiators include benzophenones/amines and thioxanthones/amines. Cationic initiators include aryldiazonium, diaryliodonium, and triarylsulfonium salts. In preferred embodiments, the photoinitiator comprises phenylbis(2,4,6-trimethylbenzoyl) phosphine oxide (BAPO), diphenyl-(2,4,6-trimethylbenzoyl) phosphine oxide (TPO), ethyl-(2,4,6-trimethylbenzoyl)phenylphosphinate (TPO-L), or a combination thereof.

In some embodiments, the photoinitiator initiates photopolymerization using light energy. In certain embodiments, the photoinitiator initiates photopolymerization with exposure to light energy from 800 nm to 250 nm, from 800 nm to 350 nm, from 800 nm to 450 nm, from 800 nm to 550 nm, from 800 nm to 650 nm, from 600 nm to 250 nm, from 600 nm to 350 nm, from 600 nm to 450 nm, or from 400 nm to 250 nm. In some embodiments, the photoinitiator initiates photopolymerization following absorption of two photons, which can use longer wavelengths of light to initiate the photopolymerization.

In some embodiments, the polymerizable composition comprises more than one polymerization initiator (e.g., 2, 3, 4, 5, or more than 5 polymerization initiators). In some embodiments, the polymerizable composition comprises a polymerization initiator that is a thermal initiator. In certain embodiments, the thermal initiator comprises an organic peroxide. In some embodiments, the thermal initiator comprises an azo compound, an inorganic peroxide, an organic peroxide, or any combination thereof. In some embodiments, the thermal initiator is selected from the group consisting of tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy) butane, 1,1-bis(tert-butylperoxy)cyclohexane, 2,5-bis(tert-butylperoxy_2,5-dimethylhexane, 2,5-bis(tert-butylperoxy)-2,5-dimethyl-3-hexyne, bis(1-(tert-butylperoxy)-3,3,5-trimethylcyclohexane, tert-butyl hydroxyperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, a derivative thereof, and a combination thereof. In preferred embodiments, the thermal initiator comprises azobisisobutyronitrile, 2,2′-azodi(2-methylbutyronitrile), or a combination thereof.

In some embodiments, the polymerizable composition further comprises one or more components selected from the group consisting of a crosslinking modifier, a glass transition temperature modifier, a polymerization catalyst, a polymerization inhibitor, a light blocker, a plasticizer, a surface energy modifier, a pigment, a dye, a filler, a biologically significant chemical, a solvent, and combinations thereof.

The polymerizable composition herein can be characterized by having one or more properties. In some embodiments, (meth)acrylate monomers of formula (B) of this disclosure can be used as a reactive diluent in polymerizable compositions disclosed herein. Hence, in some instances, a (meth)acrylate monomer of formula (B) can reduce a viscosity of the photo-polymerizable composition. In such cases, a (meth)acrylate monomer of formula (B) can reduce the viscosity of a polymerizable composition by at least about 5% compared to a resin that does not comprise the (meth)acrylate monomer of formula (B). In some instances, a (meth)acrylate monomer of formula (B) can reduce the viscosity of a polymerizable composition by at least about 5%, 10%, 20%, 30%, 40%, or 50%. In some instances, a polymerizable composition of this disclosure can have a viscosity from about 30 cP to about 50,000 cP at a printing temperature. In some embodiments, the polymerizable composition has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25° C. In some embodiments, the resin has a viscosity less than 15,000 cP at 25° C. In some embodiments, the polymerizable composition has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature. In some embodiments, the polymerizable composition has a viscosity from 50,000 cP to 30 cP, from 40,000 cP to 30 cP, from 30,000 cP to 30 cP, from 20,000 cP to 30 cP, from 10,000 cP to 30 cP, or from 5,000 cP to 30 cP at a printing temperature. In some embodiments, the printing temperature is from 0° C. to 25° C., from 25° C. to 40° C., from 40° C. to 100° C., or from 20° C. to 150° C. In some embodiments, the polymerizable composition has a viscosity from 30 cP to 50,000 cP at a printing temperature, wherein the printing temperature is from 20° C. to 150° C. In yet other embodiments, the polymerizable composition has a viscosity less than 20,000 cP at a print temperature. In some embodiments, the print temperature is from 10° C. to 200° C., from 15° C. to 175° C., from 20° C. to 150° C., from 25° C. to 125° C., or from 30° C. to 100° C. In preferred embodiments, the print temperature is from 20° C. to 150° C.

A polymerizable composition of the present disclosure can be capable of being 3D printed at a temperature greater than 25° C. In some cases, the printing temperature is at least about 30° C., 40° C., 50° C., 60° C., 80° C., or 100° C. As described herein, a photo-polymerizable monomer of this disclosure that can be part of the photo-polymerizable composition, can have a low vapor pressure and/or mass loss at the printing temperature, thereby providing improved printing conditions compared to conventional resins used in additive manufacturing.

In some embodiments, a polymerizable composition herein has a melting temperature greater than room temperature. In some embodiments, the polymerizable composition has a melting temperature greater than 20° C., greater than 25° C., greater than 30° C., greater than 35° C., greater than 40° C., greater than 45° C. greater than 50° C., greater than 55° C., greater than 60° C., greater than 65° C., greater than 70° C., greater than 75° C., or greater than 80° C. In some embodiments, the polymerizable composition has a melting temperature from 20° C. to 250° C., from 30° C. to 180° C., from 40° C. to 160° C., or from 50° C. to 140° C. In some embodiments, the polymerizable composition has a melting temperature greater than 60° C. In other embodiments, the polymerizable composition has a melting temperature from 80° C. to 110° C. In some instances, a polymerizable composition can have a melting temperature of about 80° C. before polymerization, and after polymerization, the resulting polymeric material can have a melting temperature of about 100° C.

In certain instances, it may be advantageous that a polymerizable composition is in a liquid phase at an elevated temperature. As an example, a conventional polymerizable composition can comprise polymerizable components that may be viscous at a process temperature, and thus can be difficult to use in the fabrication of objects (e.g., using 3D printing). As a solution for that technical problem, the present disclosure provides photo-polymerizable compositions comprising photo-polymerizable components such as monomers described herein that can melt at an elevated temperature, e.g., at a temperature of fabrication (e.g., during 3D printing), and can have a decreased viscosity at the elevated temperature, which can make such resin more applicable and usable for uses such as 3D printing. Hence, in some embodiments, provided herein are photo-polymerizable compositions that are a liquid at an elevated temperature. In some embodiments, the elevated temperature is at or above the melting temperature (Tm) of the photo-polymerizable composition. In certain embodiments, the elevated temperature is a temperature in the range from about 40° C. to about 100° C., from about 60° C. to about 100° C., from about 80° C. to about 100° C., from about 40° C. to about 150° C., or from about 150° C. to about 350° C. In some embodiments, the elevated temperature is a temperature above about 40° C., above about 60° C., above about 80° C., or above about 100° C. In some embodiments, a polymerizable composition herein is a liquid at an elevated temperature with a viscosity less than about 50 Pa·s, less than 2 about 0 Pa·s, less than about 10 Pa·s, less than about 5 Pa·s, or less than about 1 Pa·s. In some embodiments, a photo-curable polymerizable composition herein is a liquid at an elevated temperature of above about 40° C. with a viscosity less than about 20 Pa·s. In yet other embodiments, a polymerizable composition herein is a liquid at an elevated temperature of above about 40° C. with a viscosity less than about 1 Pa·s.

In some embodiments, at least a portion of a polymerizable composition herein has a melting temperature below about 100° C., below about 90° C., below about 80° C., below about 70° C., or below about 60° C. In some embodiments, at least a portion of a polymerizable composition herein melts at an elevated temperature between about 100° C. and about 20° C., between about 90° C. and about 20° C., between about 80° C. and about 20° C., between about 70° C. and about 20° C., between about 60° C. and about 20° C., between about 60° C. and about 10° C., or between about 60° C. and about 0° C.

In various embodiments, a polymerizable composition herein as well as its photo-polymerizable components can be biocompatible, bioinert, or a combination thereof. In various instances, the photo-polymerizable compounds of a resin herein can have biocompatible and/or bioinert metabolic (e.g., hydrolysis) products.

A polymerizable composition of the present disclosure can comprise less than about 20 wt % or less than about 10 wt % hydrogen bonding units. In some embodiments a polymerizable composition herein comprises less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % hydrogen bonding units.

### C. 3D Printed Crosslinked Polymeric Materials

The present disclosure provided a 3D printed crosslinked polymeric material from which a (meth)acrylate monomer of formula (B) can be recovered. The 3D printed crosslinked polymeric material is a cured product of a polymerizable composition described herein. In various embodiments, a 3D printed crosslinked polymeric material can comprise a copolymer formed by the free radical polymerization of one or more (meth)acrylate monomers of formula (B) and one or more telechelic compounds described herein.

The 3D printed crosslinked polymeric materials can have low amounts of water uptake and can be solvent resistant. In some embodiments, the 3D printed crosslinked polymeric materials can be characterized by one or more of the properties selected from the group consisting of elongation at break, storage modulus, tensile modulus, stress remaining, glass transition temperature, water uptake, hardness, color, transparency, hydrophobicity, lubricity, surface texture, percent crystallinity, phase composition ratio, phase domain size, and phase domain size and morphology. The 3D printed crosslinked polymeric materials provided herein can be used to form materials having favorable properties of both elasticity and stiffness for various applications, such as for forming orthodontic appliances. Specifically, a 3D printed crosslinked polymeric material of the present disclosure can provide an excellent flexural modulus, elastic modulus, elongation at break, or a combination thereof. In some embodiments, the 3D printed crosslinked polymeric materials have a crosslinking density ranging from 0.00001 to 0.01 mol/g.

In various embodiments, a 3D printed crosslinked polymeric material of the present disclosure from which a (meth)acrylate monomer of formula (B) can be recovered by thermal depolymerization comprises a monomeric unit having the following formula (XI):

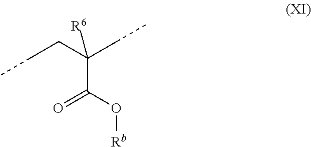

wherein:
[symbol] represents a segment of a backbone of the copolymer;
R⁶ is H, substituted or unsubstituted C₁₋₃ alkyl, or halogen; and
R^{b} is substituted or unsubstituted C₁₋₁₂ alkyl, substituted or unsubstituted C₁₋₁₂ heteroalkyl, substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl.

In some embodiments, R^{b} is substituted or unsubstituted cyclo(C₃₋₁₈) alkyl, substituted or unsubstituted cyclo(C₃₋₁₈) heteroalkyl, or substituted or unsubstituted C₁₋₁₂ alkylene-cyclo(C₃₋₁₈) heteroalkyl. In some embodiments, R^{b} is unsubstituted C₁₋₁₂ alkyl. In some embodiments, R^{b} is substituted or unsubstituted cyclo(C₃₋₁₈) alkyl. In some embodiments, R^{b} is substituted or unsubstituted cyclo(C₃₋₁₈) heteroalkyl. In some embodiments, the cyclo(C₃₋₁₈) alkyl is bicyclic. In some embodiments, R^{b} is substituted or unsubstituted C₁₋₁₂ alkylene-cyclo(C₃₋₁₈) heteroalkyl.

In certain embodiments, the monomeric unit of formula (XI) has one of the following structures:

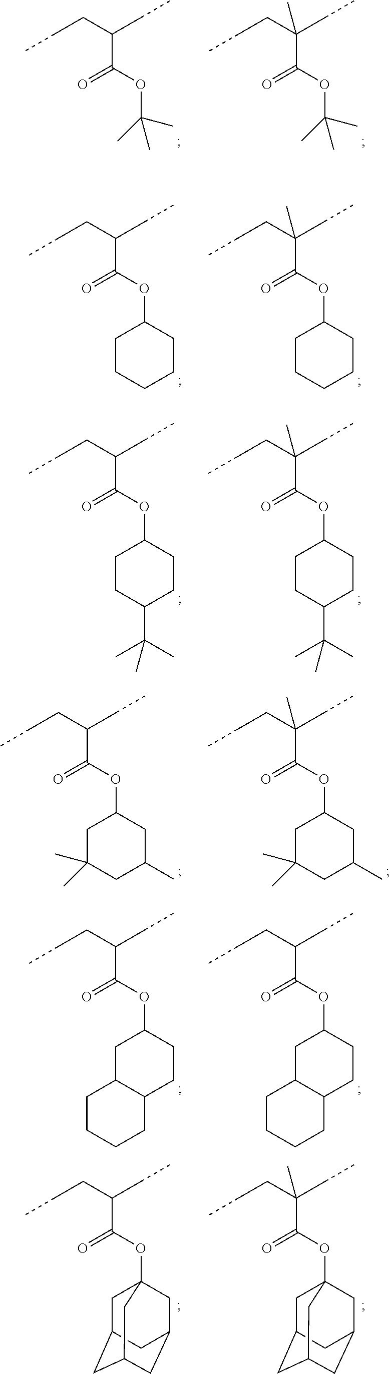

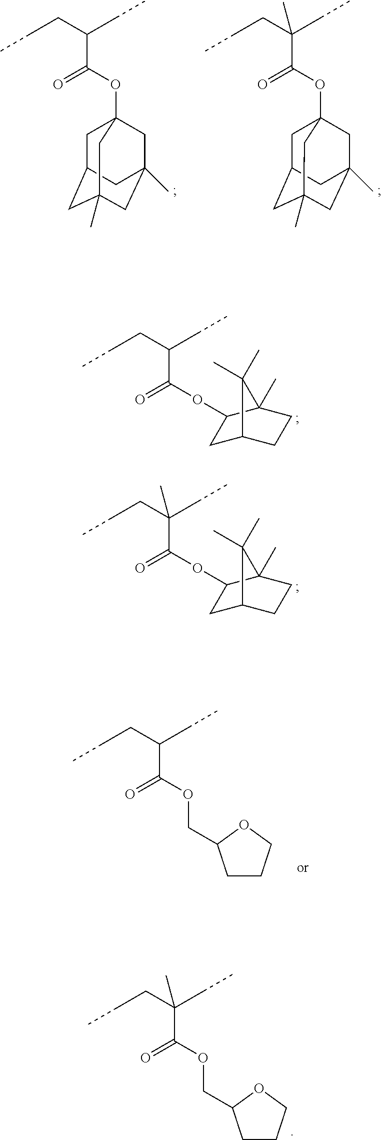

In some embodiments, R^{b} is substituted or unsubstituted aryl. In certain embodiments, the 3D printed crosslinked polymeric material comprises a monomeric unit having the following formula (XIa):

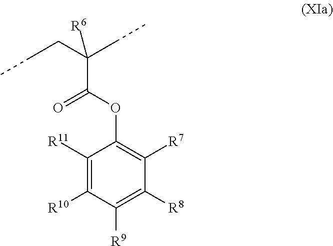

wherein:
[symbol] represents a segment of a backbone of the copolymer;
R⁶ is H, substituted or unsubstituted C₁₋₃ alkyl, or halogen; and
R⁷, R⁸, R⁹, R¹⁰ and R¹¹ are each independently H, substituted or unsubstituted C₁₋₁₂ alkyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxy, substituted or unsubstituted cyclo(C₃₋₁₈) alkyl, substituted or unsubstituted cyclo(C₃₋₁₈) heteroalkyl, substituted or unsubstituted aryl, substituted or unsubstituted heteroaryl, or —Y—(CH₂)ₙ—R¹², or R¹⁰ and R¹¹ together form a 4-, 5-, 6-, 7-, or 8-membered ring selected from substituted or unsubstituted cyclo(C₃₋₁₈) alkyl, substituted or unsubstituted cyclo(C₃₋₁₈) heteroalkyl, substituted or unsubstituted aryl, or substituted or unsubstituted heteroaryl;
wherein Y is O, S, NH, or C(O)O;
n is an integer from 0 to 6; and
R¹² is substituted or unsubstituted cyclo(C₃₋₁₈) alkyl, substituted or unsubstituted cyclo-(C₃₋₁₈) heteroalkyl, substituted or unsubstituted aryl, or substituted or unsubstituted heteroaryl.

In some embodiments, R⁶ is H or methyl.

In some embodiments, R⁷ is H or C₁₋₆ alkoxy. In some embodiments, R⁷ is methoxy.

In some embodiments, R⁸ is H.

In some embodiments, R⁹ is H, C₁₋₆ alkyl, C₁₋₆ alkoxy, or C₁₋₆ carbonyl. In some embodiments, R⁹ is methyl, ethyl, or C₁ carbonyl.

In some embodiments, R¹⁰ is H.

In some embodiments, R¹¹ is H, C₁₋₆ alkoxy, or aryl. In some embodiments, R¹¹ is methoxy or phenyl.

In some embodiments, the 3D printed crosslinked polymeric material comprises a monomeric unit having one of the following structures:

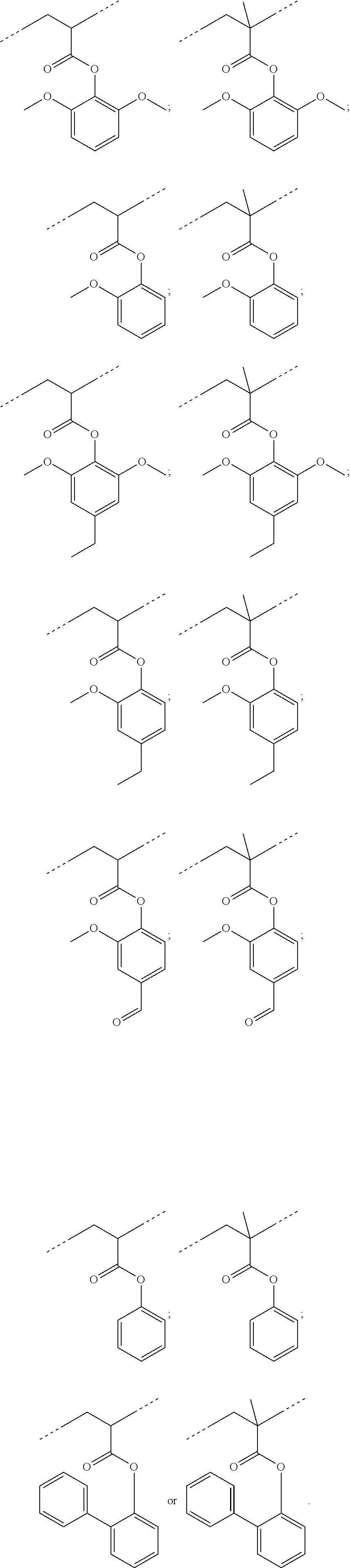

In some embodiments, the 3D printed crosslinked polymeric material further comprises a catalyst unit for facilitating depolymerization of the polymer chain. The catalyst unit is capable of reducing the temperature and/or pressure needed to initiate the depolymerization and increasing the yield of the reactive diluent monomer recovered.

In some embodiments, the catalyst unit is present in components of the polymerizable composition, and thus is incorporated into the 3D printed crosslinked polymeric material and becomes a part of the 3D printed crosslinked polymeric material after 3D printing. In some embodiments, the catalyst unit is a moiety that can lead to direct depolymerization when activated. For example, the catalyst unit may be a Raft agent, metal halide, metal, nitroxyl, oxime, or any moieties comprising weak covalent bonds. The weak covalent bonds may include, for example, imines, boronic esters, disulfides, or reversible Diels-Alder bonds. In some embodiments, the weak covalent bond is selected from a sulfur-sulfur bond, an oxygen-oxygen bond, a nitrogen-nitrogen bond, a silicone-sulfur bond, a silicone-silicone bond, a phosphorus-phosphorus bond, an oxygen-sulfur bond, a nitrogen-phosphorus bond, a carbon-phosphorus bond, a phosphorus-silicone bond, a carbon-sulfur bond, a nitrogen-oxygen bond, and a combination thereof. Such weak covalent bonds can be thermally cleaved with just heat, or in some embodiments, with additional energy (e.g., ultrasonic energy or light energy), or with an activation catalyst capable of activating the weak covalent bonds. In some embodiments, the activation catalyst can be additives such as thermal radical initiators, photoinitiators, pH modifiers, chelating agents, oxidants, reductants, photocatalysts, thermal acid generators, and thermal base generators. In some embodiments, the catalyst unit may be an in-chain catalyst such as a capping agent, initiator, or transfer agent at the polymer chain end. Examples of in-chain catalysts include, but are not limited to, nitroxyl used as an inhibitor for stabilizing the polymerizable composition before polymerization, or a reversible addition fragmentation chain transfer (RAFT) agent. In some embodiments, the in-chain catalyst is an in-chain peroxide. The in-chain peroxide can, for example, cleave in the presence of disulfide bonds, catalyzing a disulfide cleavage reaction, which causes chain scission of the 3D printed crosslinked polymeric material.

The catalyst unit may be present in the 3D printed crosslinked polymeric material either as a free agent or attached to a component of the 3D printed crosslinked polymeric material.

D. Methods of Recovering Reactive Diluent Monomers from 3D Printed Crosslinked Polymeric Materials

In various aspects, the present disclosure provides methods for chemically recycling (meth)acrylate-based reactive diluent monomers from a 3D printed crosslinked polymeric material. In various embodiments, provided herein are methods for chemically recycling a (meth)acrylate monomer of formula (B) from a 3D printed crosslinked polymeric material comprising corresponding structural units.

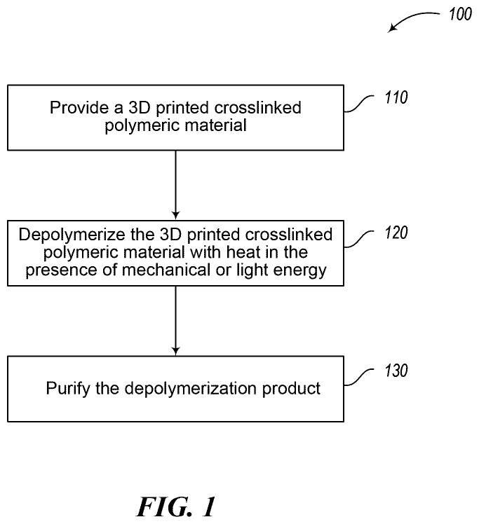

FIG. 1 is a flow diagram illustrating a method 100 for recovering a (meth)acrylate monomer of formula (B) from a 3D printed crosslinked polymeric material comprising corresponding structural units, in accordance with some embodiments. In the method 100, mechanical energy or light energy is used in conjunction with the heat to facilitate the depolymerization process, resulting in the recovering of (meth)acrylate monomer of formula (B). It is understood that the method 100 is merely an example and is not intended to limit the present disclosure beyond what is explicitly recited in the claims. Additional operations can be provided before, during, and after the method 100, and some operations described can be replaced, eliminated, or moved around for additional embodiments of the method.

Referring to FIG. 1, the method 100 comprises operation 110, wherein a 3D printed crosslinked polymeric material is provided. In some embodiments, the source of the 3D printed crosslinked polymeric material may include waste or discarded materials generated during the fabrication of an object from a polymerizable composition of the present disclosure by 3D printing. In some other embodiments, the 3D printed crosslinked polymeric material may be post-consumer recovered materials obtained from the 3D printed object. In some embodiments, such 3D printed object may be a dental device including, for example, an orthodontic appliance such as aligner, palatal expander, attachment, attachment template, or retainer, a restorative object such as crown, veneer, or implant, and/or any other dental appliances such as oral sleep apnea appliance or mouth guard. In some embodiments, the medical device may also include other polymers besides the 3D printing crosslinked polymeric material.

The 3D printed crosslinked polymeric material may be provided, for example, in the form of particles, chips, pellets, or powders. In some embodiments, the 3D printed crosslinked polymeric material may undergo pretreatment, so as to increase the surface area available for the thermal depolymerization. For example, the 3D printed crosslinked polymeric material may be mechanically ground, granulated, or pelleted to reduce the size of the material. In some embodiments, the 3D printed crosslinked polymeric material is in the form of particles having an average size less than 10,000 μm, 9,000 μm, 8,000 μm, 7,000 μm, 6,000 μm, 5,000 μm, 4,000 μm, 3,000 μm, 1,000 μm, 400 μm, or 100 μm. In some embodiments, the average size of the particles is in the range from 50 to 10,000 μm, for example, from 50 to 15.00 μm, from 70 to 1,200 μm, from 400 to 1,000 μm, or from 1,000 to 3,000 μm. In some embodiments, the average size of the particles is from 70 μm to 1,200 μm, although particles outside this range are also contemplated. In some embodiments, the size of the particles is from 100 μm to 1,000 μm, from 100 μm to 800 μm, or from 200 μm to 600 μm.

At operation 120, the 3D printed crosslinked polymeric material undergoes heating in the presence of mechanical or light energy, promoting its depolymerization into its substituent monomers. The application of mechanical or light energy allows for the depolymerization of the crosslinked polymer at temperatures below its ceiling temperature.

In some embodiments, the depolymerization of the 3D printed crosslinked polymeric material may be carried out at a temperature of between 100° C. and 250° C., for example, between 100° C. and 200° C., between 110° C. and 200° C., between 120° C. and 200° C., between 130° C. and 200° C., between 140° C. and 200° C., or between 150° C. and 200° C. In some embodiments, the temperature is about 120° C., 130° C., 140° C., 150° C., 160° C., 170° C., or 180° C. The duration of the heating may range from a few seconds to hours. In some embodiments, the time period for heating is from 1 minute to 10 minutes, 10 minutes to 30 minutes, from 30 minutes to 1 hour, from 1 hour to 5 hours, or from 5 hours to 10 hours.

The heating process may involve exposing the 3D printed crosslinked polymeric material to microwaves, pulsed electric fields, or by direct contact with a hot surface such as in an extruder, a screw conveyor, a rotating drum, etc. These hot surfaces may be heated by various means, including direct electric heating or by using heat-transfer fluids (e.g., steam, oil, molten salts, etc.).

In some embodiments, the heating of the 3D printed crosslinked polymeric material may be carried out under an inert atmosphere, such as vacuum, nitrogen, argon, or an atmosphere that is substantially low oxygen levels (e.g., containing 0.1% to 10% oxygen).

In some embodiments, the pressure during the depolymerization may be around 100 bar or less, around 50 bar or less, around 45 bar or less, around 35 bar or less, around 25 bar or less, or around 10 bar or less, for example around 8 bar or less, around 5 bar or less, around 2 bar or less, or around 1 bar or less. In some embodiments, the pressure during the depolymerization is from 5 to 45 bar, such as from 20 to 35 bar.

In some embodiments, mechanical energy is applied to the 3D printed crosslinked polymeric material concurrently with heat to aid in the depolymerization.

In some embodiments, the mechanical energy is ultrasonic energy. The ultrasonic energy may be pulsed. In some embodiments, the ultrasonic energy may have a pulse duration ranging from 100 ps to 1 ms, for example, from 100 ps to 100 ns, from 100 ns to 500 ns, from 500 ns to 1 μs, from 1 μs to 10 ns, from 10 μs to 500 μs, or from 500 μs to 1 ms, a pulse power ranging from 1 kW to 50 kW, for example, from 1 kW to 5 kW, from 5 kW to 10 kW, from 10 kW to 20 kW, or from 20 kW to 50 kW, and a frequency ranging from 100 kHz to 200 MHz, for example, from 500 kHz to 25 MHz, from 500 kHz to 200 MHz, from 1 MHz to 5 MHz, from 1 MHz to 7 MHz, from 1 MHz to 10 MHz, from 1 MHz to 20 MHz, from 1 MHz to 25 MHz, from 1 MHz to 30 MHz, from 1 MHz to 200 MHz, from 2 MHz to 5 MHz, from 2 MHz to 10 MHz, or from 2 MHz to 200 MHz. In some embodiments, the ultrasonic energy is generated using an ultrasonic transducer or ultrasonic horn.

In some embodiments, the mechanical energy is generated by ball milling. In this process, abrasive particles agitate the 3D printed crosslinked polymeric material, causing the scission of polymer chains through shear and impact forces generated by the abrasive particles. The chain scission generates radicals, initiating the depolymerization of the 3D printed crosslinked polymeric material and resulting in the production of (meth)acrylate monomers with formula (B). In some embodiments, the abrasive particles comprise zirconia (ZrO₂) or steel balls,

In some embodiments, ultraviolent (UV) radiation is applied to the 3D printed crosslinked polymeric material concurrently with heat to aid in depolymerization. The UV radiation induces photooxidative degradation, resulting in the scission of polymer chains and the generation of radicals. These radicals then initiate the depolymerization process, ultimately yielding the (meth)acrylate monomers of formula (B).

In some embodiments, thermal depolymerization can be conducted either with or without solvent. When a solvent is utilized, suitable solvents that can be employed in the present disclosure include, but are not limited to, toluene, methylene chloride, tetrahydrofuran, methyl t-butyl ether, and combinations thereof.

At operation 130, a depolymerization product may be collected at the end of the depolymerization process (operation 120). The depolymerization product may be further purified, for example, by factional distillation to afford the (meth)acrylate monomer of formula (B). The recovered (meth)acrylate monomer of formula (B) may then be reused as a reactive diluent to reduce the viscosity of a polymerizable composition for the fabrication of new devices, such as orthodontic appliances, by 3D printing.

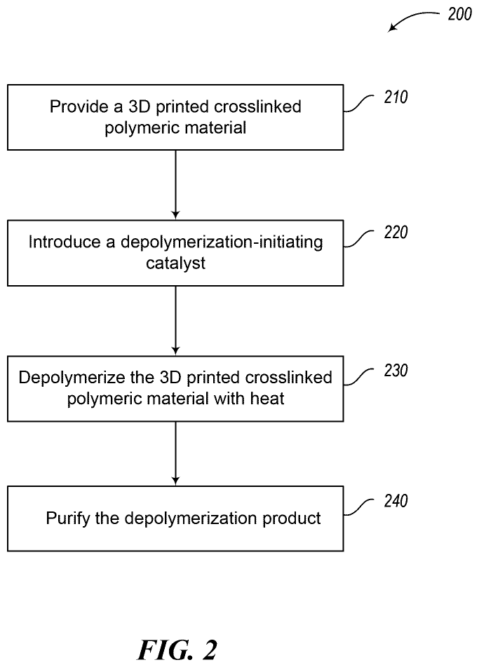

FIG. 2 is a flow diagram illustrating a method 200 for recovering a (meth)acrylate monomer of formula (B) from a 3D printed crosslinked polymeric material comprising corresponding structural units, in accordance with some embodiments of the present disclosure. Compared to the method 100, where mechanical or light energy is used to facilitate the depolymerization process, method 200 employs a depolymerization-initiating catalyst. This catalyst reduces the required temperature and/or pressure for initiating the depolymerization, leading to an increase in the chemical recycling yield. The depolymerization-initiating catalyst may be introduced after 3D printing but prior to the depolymerization process. It is understood that the method 200 is merely an example and is not intended to limit the present disclosure beyond what is explicitly recited in the claims. Additional operations can be provided before, during, and after the method 200, and some operations described can be replaced, eliminated, or moved around for additional embodiments of the method.

Referring to FIG. 2, the method 200 comprises operation 210, where a 3D printed crosslinked polymeric material from which a (meth)acrylate monomer of formula (B) can be recovered is provided. The preparation and characteristics of the 3D printed crosslinked polymeric material are described in operation 110 of method 100 and will not be reiterated here in detail.

At operation 220, a depolymerization-initiating catalyst is introduced to the 3D printed crosslinked polymeric material. In some embodiments, the depolymerization-initiating catalyst comprises a metal or a metal-containing compound which can be metal chloride, metal oxide, metal hydroxide, metal nitride, metal peroxide, metal phosphate, metal sulphonate, metal carbonate, metal carbonate peroxyhydrate, or metal stearate. Suitable metals in the metal-based catalysts include, but are not limited to, aluminum, antimony, barium, bismuth, cadmium, calcium, cerium, chromium, cobalt, copper, gallium, iron, lanthanum, lithium, magnesium, manganese, molybdenum, nickel, palladium, potassium, silver, sodium, strontium, tin, tungsten, vanadium, and zinc. In some embodiments, the catalyst is an organic catalyst including, but not limited to, an amine, azo derivative, enol, glycol, quaternary ammonium salt, phenoxide, cyanate, thiocyanate, dialkyl amide, alkyl thiolate, photoinitiator, or thermal initiator. Exemplary catalysts that may be employed in the present disclosure include, but are not limited to, copper chloride (CuCl), manganese oxide (MnO₂), ferrocene, and azobisisobutyronitrile (AIBN).

The catalyst is present in an amount sufficient to promote the depolymerization reaction. In some embodiments, the amount of catalyst ranges from 0.1 to 20 wt % based on the dry solid weight of the 3D printed crosslinked polymeric material. In certain embodiments, the amount of catalyst is from 0.1 to 18 wt %, from 0.5 to 15 wt %, from 1 to 15 wt %, or from 5 to 15 wt %. In some embodiments, the amount of catalyst is about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, or about 18 wt %.

The catalyst may be added with or without a solvent. The choice of solvent depends on factors such as catalyst solubility, water content, and/or additives in the 3D printed crosslinked polymeric material. Suitable solvents for use in the present disclosure include, but are not limited to, water, methanol, ethanol, acetone, 1,4-dioxane, dimethyl formamide (DMF), chloroform, methyl tert-butyl ether (MTBE), or combinations thereof.

At operation 230, the 3D printed crosslinked polymeric material undergoes thermal depolymerization in the presence of the catalyst, leading to the formation of (metho) acrylate monomer of formula (B). The catalyst enables depolymerization at temperatures below the ceiling temperature of the crosslinked polymeric material. Depolymerization may be initiated by the catalyst within the polymer chain at any point, or may start at one end of the polymer chain and propagate along the chain, ultimately resulting in the formation of (meth)acrylate monomer of formula (B).

The heat can be applied through various methods, such as electric heating or microwave irradiation. In some embodiments, the depolymerization of the 3D printed crosslinked polymeric material may be carried out at a temperature of between 100° C. and 250° C., for example, between 100° C. and 200° C., between 110° C. and 200° C., between 120° C. and 200° C., between 130° C. and 200° C., between 140° C. and 200° C., or between 150° C. and 200° C. In some embodiments, the temperature is about 120° C., 130° C., 140° C., 150° C., 160° C., 170° C., or 180° C. The duration of the heating may range from a few seconds to hours. In some embodiments, the time period for heating is from 1 minute to 10 minutes, 10 minutes to 30 minutes, from 30 minutes to 1 hour, from 1 hour to 5 hours, or from 5 hours to 10 hours.

In some embodiments, the heating of the 3D printed crosslinked polymeric material may be carried out under an inert atmosphere, such as vacuum, nitrogen, argon, or an atmosphere that has substantially low oxygen levels (e.g., containing from 0.1% to 10% oxygen).

In some embodiments, the pressure during the depolymerization may be around 100 bar or less, around 50 bar or less, around 45 bar or less, around 35 bar or less, around 25 bar or less, or around 10 bar or less, for example around 8 bar or less, around 5 bar or less, around 2 bar or less, or around 1 bar or less. In some embodiments, the pressure during the depolymerization is from 5 to 45 bar, such as from 20 to 35 bar.

In some embodiments, the catalyst may be allowed to reside with the 3D printed crosslinked polymeric material for a period of time before applying heat. This allows the catalyst to diffuse into the material. The residence period may range from 1 minute to 60 minutes in some embodiments, while in others, no such residence period is required.

In some embodiments, additional mechanical or light energy may be applied in conjunction with the heat to facilitate radical generation, which promotes the depolymerization of the 3D printed crosslinked polymeric material.

At operation 240, a depolymerization product may be collected at the end of the depolymerization (operation 230). The depolymerization product may be further purified, for example, by factional distillation to afford the (meth)acrylate monomer of formula (B). The recovered (meth)acrylate monomer of formula (B) may then be reused as a reactive diluent to reduce the viscosity of a polymerizable composition for the fabrication of new devices, such as orthodontic appliances, by 3D printing.

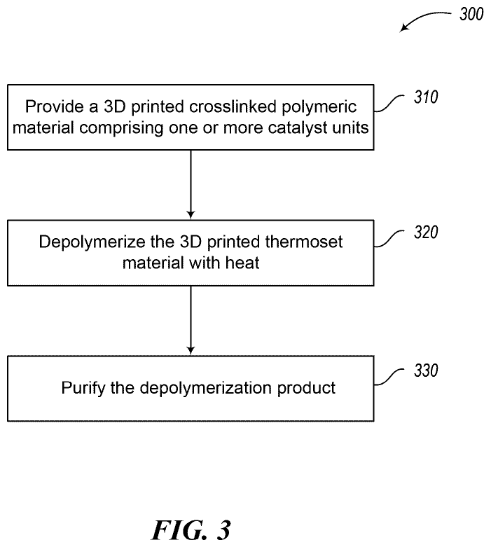

FIG. 3 is a flow diagram illustrating a method 300 for recovering a (meth)acrylate monomer of formula (B) from a 3D printed crosslinked polymeric material comprising corresponding structural units, in accordance with some embodiments of the present disclosure. In the method 300, the 3D printed crosslinked polymeric material comprises one or more catalyst units. The catalyst unit can cleave, generating radicals that initiate depolymerization of the 3D printed crosslinked polymeric material at temperatures below the ceiling temperature of the crosslinked polymer. It is understood that the method 300 is merely an example and is not intended to limit the present disclosure beyond what is explicitly recited in the claims. Additional operations can be provided before, during, and after the method 300, and some operations described can be replaced, eliminated, or moved around for additional embodiments of the method.

Referring to FIG. 3, the method 300 comprises step 310, where a 3D printed crosslinked polymeric material is provided. The 3D printed crosslinked polymeric material comprises a catalyst unit capable of generating radicals to initiate depolymerization of the 3D printed crosslinked polymeric material at temperatures below the ceiling temperature of the crosslinked polymer. In some embodiments, the catalyst unit can be a weak crosslinking unit that connects polymer chains. The weak crosslinking unit may be or may comprise a weak covalent bond with a bond dissociation energy lower than that of carbon-carbon bonds in the polymer chains. In some embodiments, the weak covalent bond is selected from a sulfur-sulfur bond, an oxygen-oxygen bond, a nitrogen-nitrogen bond, a silicone-sulfur bond, a silicone-silicone bond, a phosphorus-phosphorus bond, an oxygen-sulfur bond, a nitrogen-phosphorus bond, a carbon-phosphorus bond, a phosphorus-silicone bond, a carbon-sulfur bond, a nitrogen-oxygen bond, and a combination thereof. In some embodiments, the catalyst unit may be the capping agent, initiator, or transfer agent at the end of the polymer chain. In some embodiments, the catalyst unit may be an additive in the 3D printed crosslinked polymeric material. In some embodiments, the additive may include metal, metal oxide, metal halide, oxidant, peroxide, azo derivative, photoinitiator, thermal initiator, or inhibitor. The preparation and characteristics of the 3D printed crosslinked polymeric material are described in operation 110 of method 100 and will not be reiterated here in detail.

At operation 320, the 3D printed crosslinked polymeric material is heated. The heat causes the cleavage of the catalyst unit to generate radicals. For example, in some embodiments, the heat breaks the weak covalent bond within the catalyst unit or the weak covalent bond between the capping agent and the polymer chain to generate radicals. The radicals subsequently initiate the depolymerization of the 3D printed crosslinked polymeric material at temperatures lower than the ceiling temperature of the crosslinked polymeric material, leading to the formation of (meth)acrylate monomer of formula (B).

The heat can be applied through various methods, such as electric heating or microwave irradiation. In some embodiments, the depolymerization of the 3D printed crosslinked polymeric material may be carried out at a temperature of between 100° C. and 250° C., for example, between 100° C. and 200° C., between 110° C. and 200° C., between 120° C. and 200° C., between 130° C. and 200° C., between 140° C. and 200° C., or between 150° C. and 200° C. In some embodiments, the temperature is about 120° C., 130° C., 140° C., 150° C., 160° C., 170° C., or 180° C. The duration of the heating may range from a few seconds to hours. In some embodiments, the time period for heating is from 1 minute to 10 minutes, from 10 minutes to 30 minutes, from 30 minutes to 1 hour, from 1 hour to 5 hours, or from 5 hours to 10 hours.

In some embodiments, the heating of the 3D printed crosslinked polymeric material may be carried out under an inert atmosphere, such as vacuum, nitrogen, argon, or an atmosphere that has substantially low oxygen levels (e.g., containing from 0.1% to 10% oxygen).

In some embodiments, the pressure during the depolymerization may be around 100 bar or less, around 50 bar or less, around 45 bar or less, around 35 bar or less, around 25 bar or less, or around 10 bar or less, for example around 8 bar or less, around 5 bar or less, around 2 bar or less, or around 1 bar or less. In some embodiments, the pressure during the depolymerization is from 5 to 45 bar, such as from 20 to 35 bar.

In some embodiments, additional mechanical or light energy may be applied in conjunction with the heat to facilitate the radical generation, which promotes the depolymerization of the 3D printed crosslinked polymeric material.

At operation 330, a depolymerization product may be collected at the end of the depolymerization (operation 320). The depolymerization product may be further purified, for example, by factional distillation to afford the (meth)acrylate monomer of formula (B). The recovered (meth)acrylate monomer of formula (B) may then be reused as a reactive diluent to reduce the viscosity of a polymerizable composition for the fabrication of new devices, such as orthodontic appliances, by 3D printing.

### IV. Fabrication and Use of 3D Printed Objects

Provided herein are methods for using recovered phenol or cycloaliphatic alcohol derivatives of formula (A), e.g., by using a polymerizable compound of formula (VII) or (VIII), or using recovered (meth)acrylate monomers of formula (B) as a component of polymerizable compositions that can be cured for the fabrication of a medical device, such as an orthodontic appliance (e.g., a dental aligner, a dental expander or a dental spacer). Such polymerizable compounds and (meth)acrylate monomers can be used as reactive diluents for viscous or highly viscous photo-curable resins and can result in crosslinked polymeric materials that can have favorable thermomechanical properties as described herein (e.g., stiffness, stress remaining, etc.) for use in orthodontic appliances, for example, for moving one or more teeth of a patient.

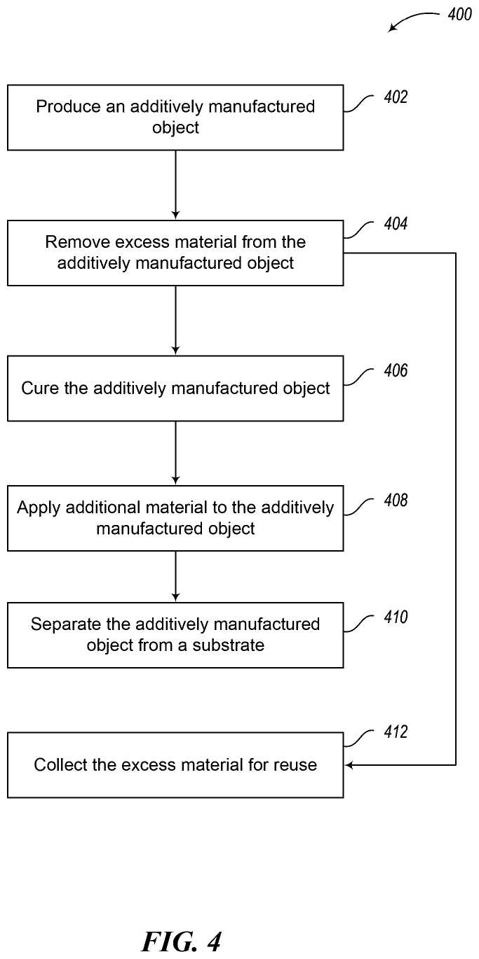

FIG. 4 is a flow diagram providing a general overview of a method 400 for fabricating and post-processing an additively manufactured object, in accordance with embodiments of the present disclosure. The method 400 can be used to produce many different types of additively manufactured objects, such as orthodontic appliances (e.g., aligners, palatal expanders, attachments, attachment templates, retainers), restorative objects (e.g., crowns, veneers, implants), and/or other dental appliances (e.g., oral sleep apnea appliances, mouth guards). Additional examples of orthodontic appliances and associated methods that are applicable to the present disclosure are described below.

The method 400 begins at operation 402 with producing an additively manufactured object. The additively manufactured object can be produced using any suitable additive manufacturing technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material (e.g., a photo-polymerizable composition) onto a build platform. The precursor material can be cured, polymerized, melted, sintered, fused, and/or otherwise solidified to form a portion of the object and/or combine the portion with previously formed portions of the object. In some embodiments, the additive manufacturing techniques provided herein build up the object geometry in a layer-by-layer fashion, with successive layers being formed in discrete build steps. Alternatively, or in combination, the additive manufacturing techniques described herein can allow for continuous build-up of an object geometry.

Examples of additive manufacturing techniques suitable for use with the methods described herein include, but are not limited to, the following: (1) vat photopolymerization, in which an object is constructed from a vat of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer-by-layer, and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding.

For example, the additively manufactured object can be fabricated using a vat photopolymerization process in which light is used to selectively cure a vat or reservoir of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the vat, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 108° C. or 110° C. The heating can lower the viscosity of the photopolymerizable material before and/or during curing. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa·s, 10 Pa·s, 15 Pa·s, 20 Pa·s, 30 Pa·s, 40 Pa·s, or 50 Pa·s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In a further example, the additively manufactured object can be fabricated using a selective laser sintering process involving using a laser beam to selectively melt and fuse a layer of powdered material according to a desired cross-sectional shape to build up the object geometry. As another example, the additively manufactured object can be fabricated using a fused deposition modeling process involving melting and selectively depositing a thin filament of thermoplastic polymer in a layer-by-layer manner to form an object. In yet another example, the additively manufactured object can be fabricated using a material jetting process involving jetting or extruding one or more materials onto a build surface to form successive layers of the object geometry.

In some embodiments, the additively manufactured object is fabricated using continuous liquid interphase production (also known as “continuous liquid interphase printing”) in which the object is continuously built up from a reservoir of photo-polymerizable composition by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path to form the object. Such methods are described in U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present disclosure include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting overlapping light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present disclosure are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after cured (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources to fabricate an object from a plurality of different materials. Examples of such methods are described in U.S. Pat. Nos. 6,749,414 and 11,318,667, the disclosures of which are incorporated herein by reference in their entirety. Alternatively, or in combination, the additively manufactured object can be formed from multiple materials in a plurality of sequential manufacturing steps. For instance, a first portion of the object can be formed from a first material in accordance with any of the methods herein, then a second portion of the object can be formed from a second material in accordance with methods herein, and so on, until the entirety of the object has been formed.

After the additively manufactured object is fabricated, the object can undergo one or more additional process steps, also referred to herein as “post-processing.” As described in detail below with respect to operations 404-412, post-processing can include removing excess material from the object, applying additional material(s) to the object, performing additional curing, separating the object from any supports or other structures that are not intended to be present in the final product, and/or collecting the removed excess material for reuse.

For example, at operation 404, the method 400 continues with removing excess material from the additively manufactured object. The excess material can include uncured material (e.g., unpolymerized liquid resin) and/or other unwanted material (e.g., debris) that remains on the additively manufactured object after fabrication. For example, certain materials used in additive manufacturing (e.g., highly viscous polymeric resins used in high temperature lithography) may adhere to the surface of the additively manufactured object. Additionally, excess material may accumulate on or within certain object features, such as cavities, crevices, indentations, apertures, etc. Accordingly, the additively manufactured object may need to be cleaned before further processing and use.

The excess material can be removed in many ways. In some embodiments, for example, the excess material is removed by rotating the additively manufactured object to centrifugally separate the excess material from the surfaces of the object. The rotation can be performed using a suitable device or system (e.g., a centrifuge) including components for supporting and applying rotational force to the additively manufactured object. Alternatively or in combination, the excess material can be removed by spraying or otherwise applying fluids (e.g., water, solvents) to the object, partially or fully immersing the object in a fluid, blowing a gas (e.g., air) on the object, applying a vacuum to the object, applying other types of mechanical forces to the object (e.g., vibration, agitation, tumbling, brushing), and/or other cleaning techniques known to those of skill in the art.

At operation 406, the method 400 can optionally include curing the additively manufactured object. This additional curing step (also known as “post-curing”) can be used in situations where the additively manufactured object is still in a partially cured “green” state after fabrication. For example, the curing energy used to fabricate the additively manufactured object at operation 402 may only partially polymerize the resin forming the object. Accordingly, the post-curing step may be needed to fully cure (e.g., fully polymerize) the additively manufactured object to its final, usable state. Post-curing can provide various benefits, such as improving the mechanical properties (e.g., stiffness, strength) and/or temperature stability of the additively manufactured object. Post-curing can be performed by heating the object, applying radiation (e.g., ultraviolet (UV), visible, microwave) to the object, or suitable combinations thereof. Post-curing can be performed by a specialized device (e.g., an oven or curing station) or can be performed by the same device used to rotate the additively manufactured object at operation 404. In other embodiments, however, the post-curing process of operation 406 is optional and can be omitted.

At operation 408, the method 400 can optionally include applying an additional material to the additively manufactured object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., an orthodontic appliance worn on the teeth); coloring and/or applying other aesthetic features to the object; improving scratch resistance and/or other mechanical properties; providing antimicrobial properties; and incorporating therapeutic agents into the object for controlled release.

At operation 410, the method 400 can include separating the additively manufactured object from a substrate. In some embodiments, the substrate is a build platform which mechanically supports the object during fabrication and the post-processing steps described herein. The additively manufactured object can be connected to the substrate via a sacrificial region of cured material. Accordingly, the additively manufactured object can be detached from the substrate by applying pressure to fracture the sacrificial region. Once separated, the additively manufactured object can then be prepared for packaging, shipment, and use.

At operation 412, the method 400 can optionally include collecting the excess material removed from the additively manufactured object at operation 404. The excess material can include uncured material that is still suitable for reuse in subsequent additive manufacturing processes (e.g., the fabrication process of operation 402). Accordingly, operation 412 can include collecting the excess material (e.g., via containers, absorbent elements, piping, etc.) and, optionally, separating reusable excess material from other unwanted components that may be present (e.g., water, solvents, debris) via filtration, distillation, centrifugation, and/or other suitable techniques.

The method 400 can be modified in many ways. For example, although the above steps of the method 400 are described with respect to a single additively manufactured object, the method 400 can be used to concurrently fabricate and post-process any suitable number of additively manufactured objects, such as tens, hundreds, or thousands of additively manufactured objects. As another example, the ordering of the steps shown in FIG. 4 can be varied, e.g., the material application process of operation 408 can be performed before the curing process of operation 406. Some of the steps of the method 400 can be omitted, such as any of operations 406, 408, and/or 412. The method 400 can also include additional steps not shown in FIG. 4.

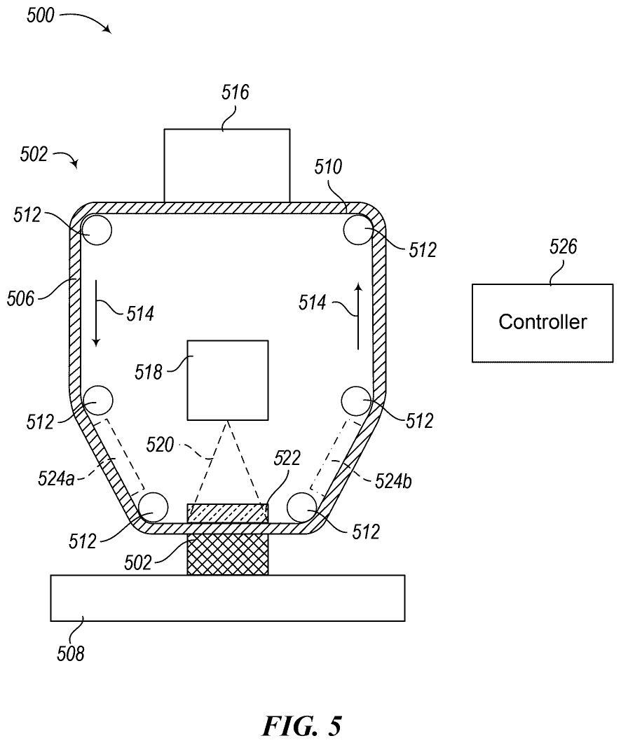

FIG. 5 illustrates a representative example of an additive manufacturing device 500 (“device 500”) configured in accordance with embodiments of the present disclosure. The device 500 can be used to fabricate any embodiment of the additively manufactured objects described herein. For example, the device 500 can be used to produce an additively manufactured object in accordance with operation 402 of the method 400 of FIG. 4.

As shown in FIG. 5, the device 500 is used to fabricate an additively manufactured object 502 (“object 502”). The device 500 includes a printer assembly 504 configured to deposit resin 506 on a build platform 508 (e.g., a tray, plate, film, sheet, or other planar substrate) to form the object 502. The printer assembly 504 includes a carrier film 510 configured to deliver the resin 506 to the build platform 508. The carrier film 510 can be a flexible loop of material having an outer surface and an inner surface. The outer surface of the carrier film 510 can adhere to and carry a thin layer of the resin 506. The inner surface of the carrier film 510 can contact one or more rollers 512 that rotate to move the carrier film 510 in a continuous loop trajectory, e.g., as indicated by arrows 514.

The printer assembly 504 can also include a resin source 516 (shown schematically) configured to apply the resin 506 to the carrier film 510. In the illustrated embodiment, the resin source 516 is located at the upper portion of the printer assembly 504 near an upper horizontal segment of the carrier film 510. In other embodiments, however, the resin source 516 can be positioned at a different location in the printer assembly 504. The resin source 516 can include nozzles, ports, reservoirs, etc., that deposit the resin 506 onto the outer surface of the carrier film 510. The resin source 516 can also include one or more blades (e.g., doctor blades, recoater blades) that smooth the deposited resin 506 into a relatively thin, uniform layer. In some embodiments, the resin 506 is formed into a layer having a thickness within a range from 200 microns to 300 microns.

The resin 506 can be carried by the carrier film 510 toward the build platform 508. In the illustrated embodiment, the build platform 508 is located below the printer assembly 504 near a lower horizontal segment of the carrier film 510. In other embodiments, however, the build platform 508 can be positioned at a different location relative to the printer assembly 504. The printer assembly 504 includes a light source 518 (e.g., a projector or light engine) that outputs light 520 (e.g., UV light) having a wavelength configured to cure the resin 506 partially or fully. The carrier film 510 can be optically transparent so that the light 520 from the light source 518 passes through the carrier film 510 and onto the portion of the resin 506 above the build platform 508, thus forming a layer of cured resin 506 onto the build platform 508 and/or a previously formed portion of the object 502. The light 520 can be patterned or scanned in a suitable pattern corresponding to the desired cross-section geometry for the object 502. Optionally, a transparent plate 522 can be disposed between the light source 518 and the carrier film 510 to guide the carrier film 510 into a specific position (e.g., height) relative to the build platform 508.

Once the object cross-section has been formed, the build platform 508 can be lowered by a predetermined amount to separate the cured resin from the carrier film 510. The remaining uncured resin 506 can be carried by the carrier film 510 away from the build platform 508 and back toward the resin source 516. The resin source 516 can deposit additional resin 506 onto the carrier film 510 and/or smooth the resin 506 to re-form a uniform layer of resin 506 on the carrier film 510. The resin 506 can then be recirculated back to the build platform 508 to fabricate an additional layer of the object 502. This process can be repeated to iteratively build up individual object layers on the build platform 508 until the object 502 is complete. The object 502 and build platform 508 can then be removed from the device 500 for post-processing.

In some embodiments, the device 500 is used in a high temperature lithography process utilizing a highly viscous resin. Accordingly, the printer assembly 504 can include one or more heat sources (heating plates, infrared lamps, etc.) for heating the resin 506 to lower the viscosity to a range suitable for additive manufacturing. For example, the printer assembly 504 can include a first heat source 524a positioned against the segment of the carrier film 510 before the build platform 508, and a second heat source 524b positioned against the segment of the carrier film 510 after the build platform 508. Alternatively, or in combination, the printer assembly 504 can include heat sources at other locations.

The device 500 also includes a controller 526 (shown schematically) that is operably coupled to the printer assembly 504 and build platform 508 to control the operation thereof. The controller 526 can be or include a computing device including one or more processors and memory storing instructions for performing the additive manufacturing operations described herein. For example, the controller 526 can receive a digital 3D model of the object 502 to be fabricated, determine a plurality of object cross-sections to build up the object 502 from the resin 506, and can transmit instructions to the light source 518 to output light 520 to form the object cross-sections. As another example, the controller 526 can also determine and control other operational parameters, such as the positioning of the build platform 508 (e.g., height) relative to the carrier film 510, the movement speed and direction of the carrier film 510, the amount of resin 506 deposited by the resin 506, the thickness of the resin layer on the carrier film 510, and/or the amount of heating applied to the resin 506.

Although FIG. 5 illustrates a representative example of an additive manufacturing device, this is not intended to be limiting, and the embodiments described herein can be used in combination with other types of additive manufacturing devices (e.g., vat-based systems) and/or other types of additive manufacturing processes (e.g., material jetting, binder jetting, FDM, powder bed fusion, sheet lamination, directed energy deposition).

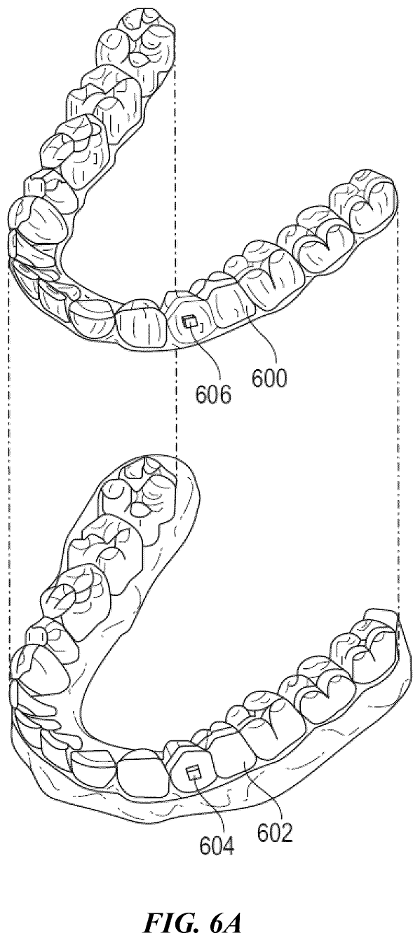

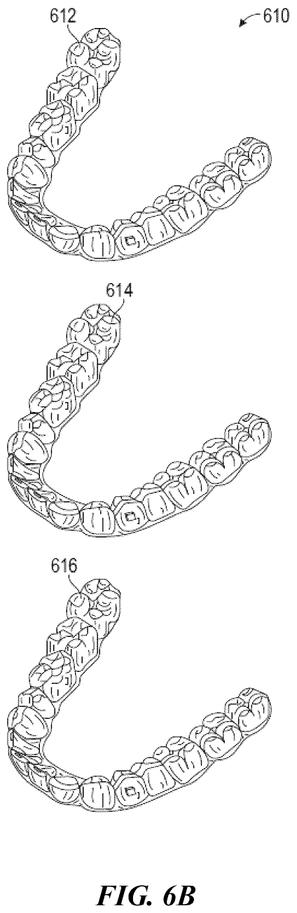

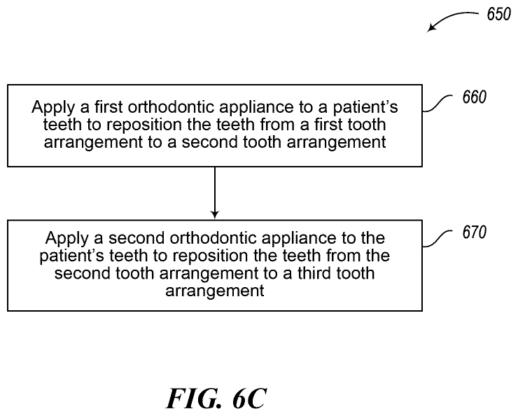

FIG. 6A illustrates a representative example of a tooth repositioning appliance 600 configured in accordance with embodiments of the present disclosure. The appliance 600 can be manufactured and post-processed using any of the systems, methods, and devices described herein. The appliance 600 (also referred to herein as an “aligner”) can be worn by a patient to achieve an incremental repositioning of individual teeth 602 in the jaw. The appliance 600 can include a shell (e.g., a continuous polymeric shell or a segmented shell) having teeth-receiving cavities that receive and resiliently reposition the teeth. The appliance 600 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using rapid prototyping fabrication techniques, from a digital model of an appliance. In some embodiments, direct fabrication involves forming an object (e.g., an appliance or a portion thereof) without using a physical template (e.g., mold, mask etc.) to define the object geometry. Though the discussion herein refers to “aligners,” any or all the discussion herein can refer to clear retainers used to retain a person's dentition at a target, final, intermediate, etc. stage of a treatment plan.

The appliance 600 can fit over all teeth present in an upper or lower jaw, or less than all the teeth. The appliance 600 can be designed specifically to accommodate the teeth of the patient (e.g., the topography of the tooth-receiving cavities matches the topography of the patient's teeth) and may be fabricated based on positive or negative models of the patient's teeth generated by impression, scanning, and the like. Alternatively, the appliance 600 can be a generic appliance configured to receive the teeth, but not necessarily shaped to match the topography of the patient's teeth. In some cases, only certain teeth received by the appliance 600 are repositioned by the appliance 600 while other teeth can provide a base or anchor region for holding the appliance 600 in place as it applies force against the tooth or teeth targeted for repositioning. In some cases, some, most, or even all the teeth can be repositioned at some point during treatment. Teeth that are moved can also serve as a base or anchor for holding the appliance as it is worn by the patient. In preferred embodiments, no wires or other means are provided for holding the appliance 600 in place over the teeth. In some cases, however, it may be desirable or necessary to provide individual attachments 604 or other anchoring elements on teeth 602 with corresponding receptacles 606 or apertures in the appliance 600 so that the appliance 600 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 6B illustrates a tooth repositioning system 610 including a plurality of appliances 612, 614, 616, in accordance with embodiments of the present disclosure. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 610 can include a first appliance 612 corresponding to an initial tooth arrangement, one or more intermediate appliances 614 corresponding to one or more intermediate arrangements, and a final appliance 616 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 6C illustrates a method 650 of orthodontic treatment using a plurality of appliances, in accordance with embodiments of the present disclosure. The method 650 can be practiced using any of the appliances or appliance sets described herein. At operation 660, a first orthodontic appliance is applied to a patient's teeth to reposition the teeth from a first tooth arrangement to a second tooth arrangement. At operation 670, a second orthodontic appliance is applied to the patient's teeth to reposition the teeth from the second tooth arrangement to a third tooth arrangement. The method 650 can be repeated as necessary using any suitable number and combination of sequential appliances to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied to compensate for any inaccuracies or limitations of the appliance.

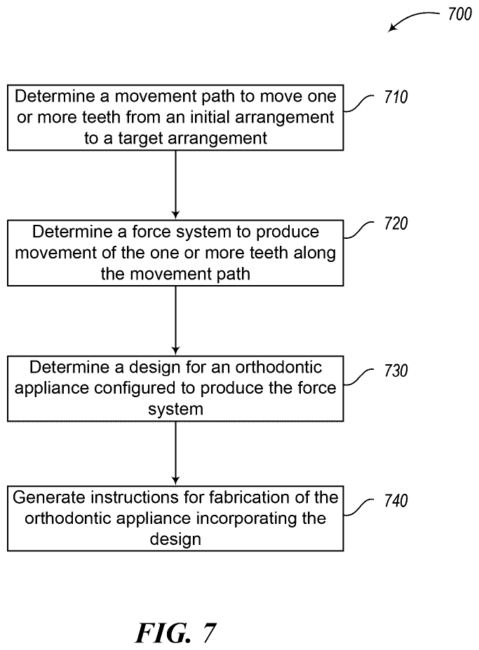

FIG. 7 illustrates a method 700 for designing an orthodontic appliance, in accordance with embodiments of the present disclosure. The method 700 can be applied to any embodiment of the orthodontic appliances described herein. Some or all the steps of the method 700 can be performed by any suitable data processing system or device, e.g., one or more processors configured with suitable instructions.

At operation 710, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

At operation 720, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully formed suture. Thus, in juvenile patients and others without fully closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

At operation 730, a design for an orthodontic appliance configured to produce the force system is determined. The design can include the appliance geometry, material composition, and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, Calif. For creating finite element models and analyzing them, program products from several vendors can be used, including finite element analysis packages from ANSYS, Inc., of Canonsburg, Pa., and SIMULIA (Abaqus) software products from Dassault Systèmes of Waltham, Mass.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

At operation 740, instructions for fabrication of the orthodontic appliance incorporating the design are generated. The instructions can be configured to control a fabrication system or device to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 400 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 700 may be performed with any suitable fabrication system or device, such as the embodiments described herein. Some of the steps may be optional, and the order of the steps can be varied as desired.

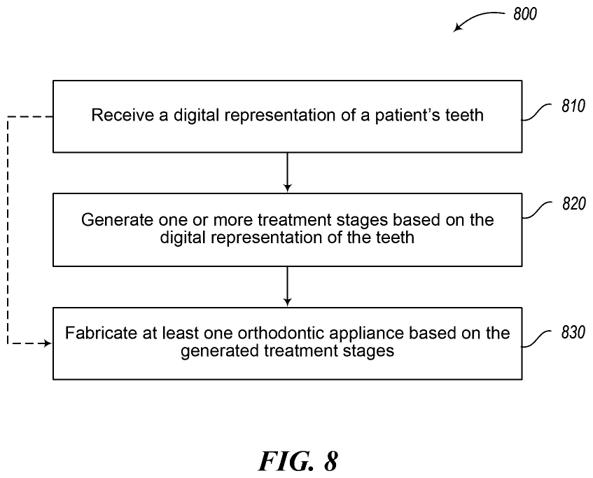

FIG. 8 illustrates a method 800 for digitally planning an orthodontic treatment and/or design or fabrication of an appliance, in accordance with embodiments. The method 800 can be applied to any of the treatment procedures described herein and can be performed by any suitable data processing system.

At operation 810, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

At operation 820, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

At operation 830, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 8, design and/or fabrication of an orthodontic appliance, and perhaps a particular orthodontic treatment, may include use of a representation of the patient's teeth (e.g., including receiving a digital representation of the patient's teeth (operation 810)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment fabrication templates, e.g., appliances used to position prefabricated attachments on a person's teeth in accordance with one or more aspects of a treatment plan. Examples of attachment fabrication templates can be found at least in: U.S. application Ser. No. 17/249,218, entitled, “Flexible 3D Printed Orthodontic Device,” filed Feb. 24, 2021; U.S. application Ser. No. 16/366,686, entitled, “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled, “Dental Attachment Placement Structure,” filed Jun. 14, 2017; U.S. application Ser. No. 14/963,527, entitled, “Dental Attachment Placement Structure,” filed Dec. 9, 2015; U.S. application Ser. No. 14/939,246, entitled, “Dental Attachment Placement Structure,” filed Nov. 12, 2015; U.S. application Ser. No. 14/939,252, entitled, “Dental Attachment Formation Structures,” filed Nov. 12, 2015; and U.S. Pat. No. 9,700,385, entitled, “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled, “Releasable Palatal Expanders,” filed Apr. 10, 2019; U.S. application Ser. No. 16/022,552, entitled, “Devices, Systems, and Methods for Dental Arch Expansion,” filed Jun. 28, 2018; U.S. Pat. No. 11,045,283, entitled, “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled, “Methods and Apparatuses for Customizing a Rapid Palatal Expander,” filed Dec. 4, 2017; and U.S. Pat. No. 7,192,273, entitled, “System and Method for Palatal Expansion,” filed Aug. 7, 2003; all of which are incorporated by reference herein in their entirety.

### V. Experimental Methods

All chemicals were purchased from commercial sources and were used without further purification, unless otherwise stated.

Additive manufacturing or 3D printing processes for generating a device herein (e.g., an orthodontic appliance) can be conducted using a Hot Lithography apparatus prototype from Cubicure (Vienna, Austria), which can substantially be configured as schematically shown in FIG. 5. In such cases, a photo-curable composition (e.g., resin) according to the present disclosure can be filled into the transparent material vat of the apparatus shown in FIG. 5, which vat can be heated to 90-110° C. The building platform can be heated to 90-110° C., too, and lowered to establish holohedral contact with the upper surface of the curable composition. By irradiating the composition with 375 nm UV radiation using a diode laser from Soliton, which can have an output power of 70 mW, which can be controlled to trace a predefined prototype design, and alternately raising the building platform, the composition can be cured layer by layer by a photopolymerization process according to the disclosure, resulting in a polymeric material according to present disclosure.

### EXAMPLES

The following examples are given for the purpose of illustrating various embodiments of the invention and are not meant to limit the present disclosure in any fashion. The present examples, along with the methods described herein are presently representative of some embodiments, are exemplary, and are not intended as limitations on the scope of the invention. Changes therein and other uses which are encompassed within the spirit of the invention as defined by the scope of the claims will occur to those skilled in the art.

### Example 1

### Recovery of Syringol from Polymeric Material

This example describes the recovery of syringol from crosslinked polymeric materials using a base-catalyzed high temperature transesterification reaction, which in various cases can be a medical device comprising such crosslinked polymeric material, e.g., an orthodontic appliance.

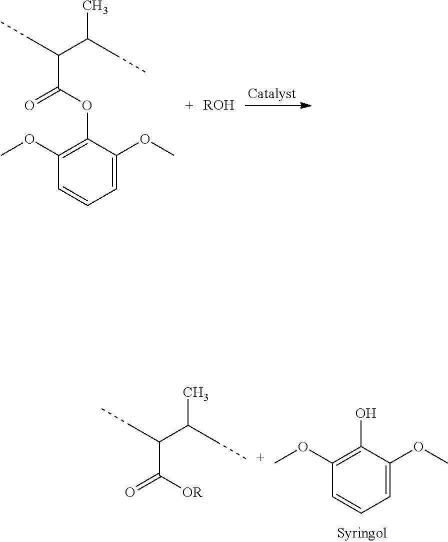

To that end, an aligner feedstock comprising a crosslinked polymeric material comprising a syringyl methacrylate ((SMA) monomeric unit (180 g), an alcohol (ROH, 1.08 L, 6 eq.), and a transesterification catalyst (0.1 eq. or 1 eq.) were loaded into a Parr reactor. The reaction was carried out at 250° C. for 2-3 hours. After the transesterification rection, the solid residue was removed by filtering and the alcohol was removed by rotary evaporation. The crude oil was subsequently distilled under vacuum at 1 mmHg and 120-150° C. to produce syringol. The components used in the transesterification reaction and the reaction conditions for recovery of syringol from an aligner feedstock and the recovery yields are provided in TABLE 1.

TABLE 1

| | | | | | | | Re- |
|---|---|---|---|---|---|---|---|
| | Aligner | | | Temp. | Pressure | Time | covery |
| | (g) | Alcohol (ROH) | Catalyst | (° C.) | (psi) | (h) | (%) |
| 1 | 180 | Butanol | Zn(OAc)₂ | 245 ± 5 | 330-360 | 2-3 | 19 |
| | | | (0.1 eq) | | | | |
| 2 | 180 | Methoxyethanol | Zn(OAc)₂ | 245 ± 5 | 240-260 | 2-3 | 22 |
| | | | (0.1 eq) | | | | |
| 3 | 180 | Methoxyethanol | TBD | 245 ± 5 | 240-260 | 2-3 | 41 |
| | | | (0.1 eq) | | | | |
| 4 | 180 | Butanol | PPh₃ | 245 ± 5 | 330-360 | 2-3 | 18 |
| | | | (0.1 eq) | | | | |
| 5 | 180 | Butanol | DMAP | 245 ± 5 | 330-360 | 2-3 | 21 |
| | | | (0.1 eq) | | | | |
| 6 | 180 | Ethylene glycol | Zn(OAc)₂ | 245 ± 5 | 50-60 | 2-3 | 20 |
| | | | (0.1 eq) | | | | |
| 7 | 180 | Ethylene glycol | DMAP | 245 ± 5 | 50-60 | 2-3 | 25 |
| | | | (0.1 eq) | | | | |
| 8 | 180 | Butanol | K₂CO₃ | 245 ± 5 | 330-360 | 2-3 | 65-70 |
| | | | (1.0 eq) | | | | |
| 9 | 180 | Butanol | KHCO₃ | 245 ± 5 | 330-360 | 2-3 | 65 |
| | | | (1.0 eq) | | | | |

### Example 2

This example describes the recovery of syringol from crosslinked polymeric materials with metal alkoxide by a transesterification reaction, which in various cases can be a medical device comprising such crosslinked polymeric material, e.g., an orthodontic appliance.

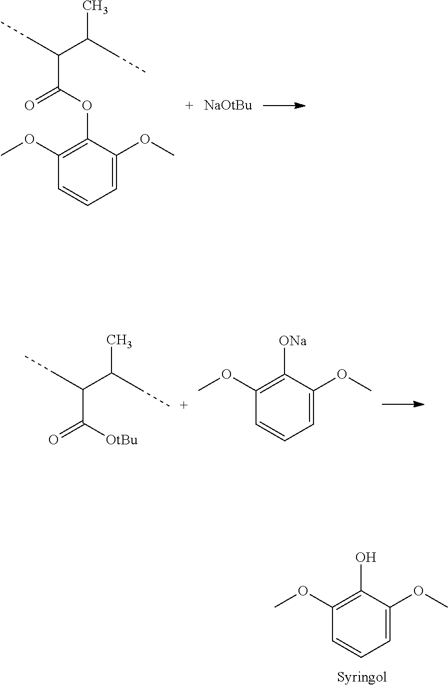

To that end, components of an aligner feedstock comprising a crosslinked polymeric material comprising a syringyl methacrylate (SMA) monomeric unit, sodium tert-butoxide, and a solvent were mixed and the mixture was reacted at 80-180° C. for 3-24 hours. After the transesterification reaction is completed, the mixture was cooled down to room temperature and the solid was filtered out. The liquid phase was neutralized with 2M HCl, and extracted with ethyl acetate. The organic phases were combined and washed with saturated brine. The resulting crude oil is distilled at 1 mmHg and 120-150° C. to produce syringol. The components used in the transesterification reaction and the reaction conditions for recovery of syringol from an aligner feedstock and the recovery yields are provided in TABLE 2. The results obtained using inorganic bases by a hydrolysis reaction are also provided as control (control 1 and control 2).

TABLE 2

| | | | | | | Re- |
|---|---|---|---|---|---|---|
| | | | | | | cov- |
| | | | | Temp. | Time | ery |
| | Aligner | Solvent | Base | (° C.) | (h) | (%) |
| 1 | 0.1 g | Butanol | sodium. | 120 | 3 | 8 |
| | | (100 vol; 10 ml) | tert-butoxide | | | |
| | | | (3.85 eq) | | | |
| 2 | 0.1 g | Dimethylformamide | sodium | 120 | 3 | 56 |
| | | (100 vol; 10 ml) | tert-butoxide | | | |
| | | | (3.85 eq ) | | | |
| 3 | 0.1 g | Ethylene glycol | sodium tert- | 180 | 18 | 25 |
| | | (100 vol; 10 ml) | butoxide | | | |
| | | | (3.85 eq ) | | | |
| 4 | 0.1 g | Dioxane | sodium | 100 | 18 | 28 |
| | | (100 vol; 10 ml) | tert-butoxide | | | |
| | | | (3.85 eq ) | | | |
| 5 | 0.1 g | 2-Methyl- | sodium | 80 | 18 | 22 |
| | | tetrahydrofuran | tert-butoxide | | | |
| | | (100 vol; 10 ml) | (3.85 eq ) | | | |
| 6 | 0.1 g | Dimethyl sulfoxide | sodium | 120 | 18 | 86 |
| | | (100 vol; 10 ml) | tert-butoxide | | | |
| | | | (3.85 eq ) | | | |
| 7 | 0.1 g | Dimethyl sulfoxide | sodium | 120 | 18 | 44 |
| | | (100 vol; 10 ml) | tert-butoxide | | | |
| | | | (1.93 eq ) | | | |
| 8 | 0.1 g | Dimethyl sulfoxide | sodium | 120 | 18 | 100 |
| | | (100 vol; 10 ml) | tert-butoxide | | | |
| | | | (7.7 eq ) | | | |
| 9 | 0.1 g | Cyclopentyl | sodium | 100 | 18 | 28 |
| | | methyl ether | tert-butoxide | | | |
| | | (100 vol; 10 ml) | (3.85 eq ) | | | |
| 10 | 3 g | Dimethyl sulfoxide | sodium | 120 | 18 | 78 |
| | | (11 vol; 30 ml) | tert-butoxide | | | |
| | | | (3.85 eq) | | | |
| 11 | 50 g | Dimethyl sulfoxide | sodium | 120 | 18 | 61 |
| | | (10 vol; 500 ml) | tert-butoxide | | | |
| | | | (3.85 eq ) | | | |
| 12 | 3 g | N-methyl-2- | sodium tert- | 120 | 18 | 53 |
| | | pyrrolidone | butoxide | | | |
| | | (10 vol; 30 ml) | (3.85 eq ) | | | |
| 13 | 50 g | Dimethyl sulfoxide | sodium | 120 | 18 | 72 |
| | | (8 vol; 400 ml) | tert-butoxide | | | |
| | | | (3.85 eq ) | | | |
| 14 | 3 g | N-methyl-2- | sodium tert- | 100 | 18 | 64 |
| | | pyrrolidone | butoxide | | | |
| | | (10 vol; 30 ml) | (3.85 eq ) | | | |
| 15 | 3 g | N-methyl-2- | sodium tert- | 80 | 18 | 53 |
| | | pyrrolidone | butoxide | | | |
| | | (10 vol; 30 ml) | (3.85 eq ) | | | |
| 16 | 3 g | N-methyl-2- | 6 M NaOH | 100 | 18 | 44 |
| | | pyrrolidone | (3.85 eq ) | | | |
| | | (10 vol; 30 ml) | | | | |
| 17 | 3 g | N-methyl-2- | 6 M K2CO3 | 100 | 18 | 8 |
| | | pyrrolidone | (3.85 eq ) | | | |
| | | (10 vol; 30 ml) | | | | |
| 18 | 3 g | N-methyl-2- | sodium tert- | 100 | 18 | 56 |
| | | pyrrolidone | butoxide | | | |
| | | (10 vol; 30 ml) | (2 eq ) | | | |
| 19 | 3 g | N-methyl-2- | sodium tert- | 100 | 18 | 56 |
| | | pyrrolidone | butoxide | | | |
| | | & CPME | (2 eq ) | | | |
| | | (5 vol & 5 | | | | |
| | | vol; 30 ml) | | | | |
| 20 | 3 g | N-methyl-2- | sodium tert- | 100 | 18 | 53 |
| | | pyrrolidone | butoxide | | | |
| | | (10 vol; 30 ml) | & K2CO3 | | | |
| | | | (2 eq & 3eq) | | | |
| Con- | 0.1 g | Dimethyl sulfoxide | Cs₂CO₃ | 120 | 18 | 25 |
| trol | | (100 vol; 10 ml) | (3.85 eq ) | | | |
| 1 | | | | | | |
| Con- | 0.1 g | Dimethyl sulfoxide- | KOH | 120 | 18 | 61 |
| trol | | water (9:1) | (3.85 eq ) | | | |
| 2 | | (100 vol; 10 g) | | | | |

### Example 3

### Thermal Depolymerization of Syringyl Methacrylate (SMA)-PolyTHF Crosslinked Polymeric Material

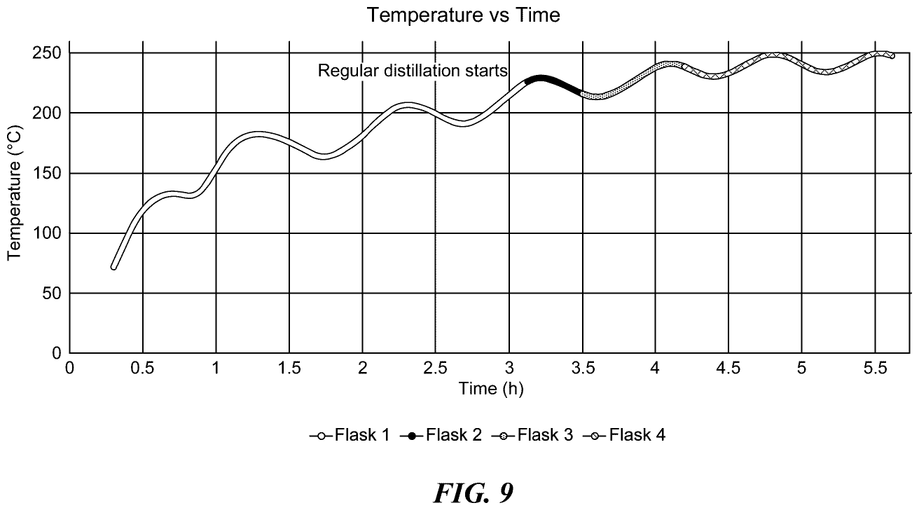

This example describes thermal depolymerization of SMA-PolyTHF crosslinked polymeric material. The SMA-PolyTHF crosslinked polymeric material was depolymerized by ramping up the temperature from 60° C. to 250° C. for a period of time from 0.25 h to 5 h. The effects of temperatures and reaction times on the depolymerization reaction were investigated and the results are depicted in FIG. 9 and summarized in TABLE 3. Overall, the combined conversion of SMA-PolyTHF to SMA and syringol is 24%, with a roughly 1:1 ratio between SMA and syringol.

TABLE 3

| SMA-PolyTHF | Distillate Mass (g) | Syringol (%) | SMA (%) |
|---|---|---|---|
| Experiment 1 (Flask 1) | 0.9029 | 59.22 | 40.78 |
| Experiment 2 (Flask 2) | 0.5767 | 28.12 | 71.88 |
| Experiment 3 (Flask 3) | 0.8903 | 45.72 | 52.38 |
| Experiment 1 (Flask 4) | 1.629 | 61.35 | 47.41 |
| Total | 3.9989 | 52.95 | 47.41 |

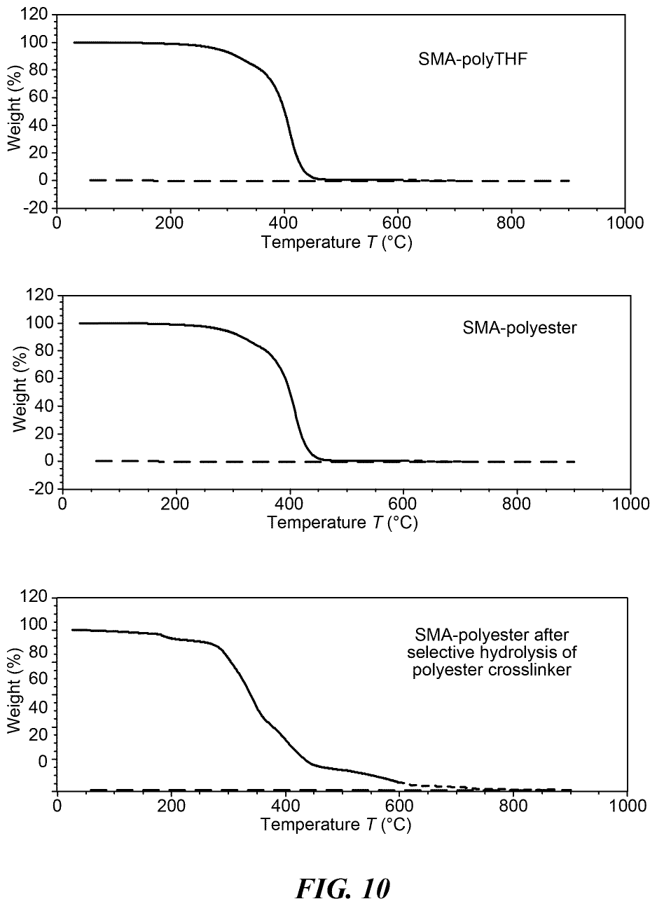

The thermal decomposition properties of crosslinked polymeric materials including SMA-PolyTHF, SMA-polyester, and SMA-polyester after selective hydrolysis of polyester crosslinker, were studied by thermogravimetric analysis (TGA). The samples were heated from ambient to 900° C. under nitrogen. The TGA thermograms are provided in FIG. 10. As shown in FIG. 10, both SMA-PolyTHF and SMA-polyester start weight loss at around 300° C. After selective hydrolysis of the polyester crosslinker, the weight loss of the de-hydrolyzed SMA-polyester starts at a much lower temperature of 200° C.

### Example 4

### Treatment Using an Orthodontic Appliance Comprising Recovered Material

This example describes the use of a directly 3D printed orthodontic appliance comprising polymeric material comprising recovered pendant groups, to move a patient's teeth according to a treatment plan. This example also describes the characteristics that the orthodontic appliance can have following its use, in contrast to its characteristics prior to use.

A patient in need of, or desirous of, a therapeutic treatment to rearrange at least one tooth has their teeth arrangement assessed. An orthodontic treatment plan is generated for the patient. The orthodontic treatment plan comprises a plurality of intermediate tooth arrangements for moving teeth along a treatment path, from the initial arrangement (e.g., that which was initially assessed) toward a final arrangement. The treatment plan includes the use of an orthodontic appliance, fabricated using photo-curable resins and methods disclosed further herein, to provide orthodontic appliances having low levels of hydrogen bonding units. In some embodiments, a plurality of orthodontic appliances is used, each of which can be fabricated using the photo-curable resins comprising one or more polymerizable monomers and methods disclosed further herein.

The orthodontic appliances are provided, and iteratively applied to the patient's teeth to move the teeth through each of the intermediate tooth arrangements toward the final arrangement. The patient's tooth movement is tracked. A comparison is made between the patient's actual teeth arrangement and the planned intermediate arrangement. Where the patient's teeth are determined to be tracking according to the treatment plan, but have not yet reached the final arrangement, the next set of appliances can be administered to the patient. The threshold difference values of a planned position of teeth to actual positions selected as indicating that a patient's teeth have progressed on-track are provided in TABLE 4. If a patient's teeth have progressed at or within the threshold values, the progress is considered to be on-track. Favorably, the use of the appliances disclosed herein increases the probability of on-track tooth movement.

TABLE 4

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The assessment and determination of whether treatment is on-track can be conducted, for example, 1 week (7 days) following the initial application of an orthodontic appliance. Following this period of application, additional parameters relating to assessing the durability of the orthodontic appliance can also be conducted. For example, relative repositioning force (compared to that which was initially provided by the appliance), remaining flexural stress, relative flexural modulus, and relative elongation at break can be determined.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by some embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

1. A method for recovering a hydroxyl-containing compound from a 3D printed object feedstock, comprising:
providing the 3D printed object feedstock comprising a crosslinked polymeric material, wherein the crosslinked polymeric material comprises an ester pendant group derived from the hydroxyl-containing compound;
transesterifying the ester pendant group with a transesterification agent, to form a mixture comprising the hydroxyl-containing compound; and
isolating the hydroxyl-containing compound from the mixture,
wherein the hydroxyl-containing compound is a compound of formula (A): 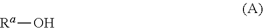
wherein R^{a} is substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl or substituted or unsubstituted C₁₋₁₂ alkylene-cyclo(C₃₋₁₈) heteroalkyl.

2. The method of claim 1, wherein the hydroxyl-containing compound is a phenol derivative and the ester pendant group is a phenolic ester pendant group, the method comprising:
transesterifying the phenolic ester pendant group to form a mixture comprising the phenol derivative; and
isolating the phenol derivative from the mixture,
wherein the phenol derivative is a compound of formula (I): 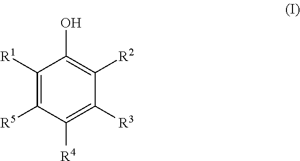
wherein R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl or substituted or unsubstituted heteroaryl.

3. The method of claim 1, wherein the hydroxyl-containing compound is a cycloaliphatic alcohol derivative and the ester pendant group is a cycloaliphatic ester pendant group, the method comprising:
transesterifying the cycloaliphatic ester pendant group to form a mixture comprising the cycloaliphatic alcohol derivative; and
isolating the cycloaliphatic alcohol derivative from the mixture,
wherein the cycloaliphatic alcohol derivative is a compound of formula (III): 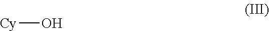
wherein Cy is substituted or unsubstituted cyclo(C₃₋₁₈) alkyl.

4. The method of claim 1, wherein the transesterification agent is an alcohol, wherein the alcohol comprises a saturated aliphatic monoalcohol, a cycloaliphatic alcohol, an aromatic alcohol, an unsaturated aliphatic monoalcohol, an alkoxy alcohol, a glycol or a glycol ether, and wherein transesterifying the ester pendant group with the alcohol is carried out in the presence of a transesterification catalyst.

5. The method of claim 4, wherein the alcohol comprises n-butanol, methoxy ethanol or ethylene glycol.

6. (canceled)

7. The method of claim 4, wherein the transesterification catalyst comprises an inorganic catalyst, an organocatalyst, an organometallic catalyst or combinations thereof.

8. The method of claim 7, wherein the inorganic catalyst comprises potassium carbonate (K₂CO₃), caesium carbonate (Cs₂CO₃), potassium hydrogen carbonate (KHCO₃) or combinations thereof, wherein the organocatalyst comprises 1,4-diazabicyclo[2.2.2]octane, triazobicyclodecene (TPD), triphenylphosphine (PPH₃), 4-dimethylaminopyridine (DMAP) or combinations thereof, and wherein the organometallic catalyst comprises zinc acetate (Zn(OAc)₂), zinc acetylacetonate, zinc acetylacetonate hydrate, bis(2,6-dimethyl-3,5-heptanedionato) zinc, bis(2,2,6,6-tetramethyl-3,5-heptanedionato) zinc, bis(5,5-dimethyl-2,4-hexanedionato) zinc, zirconium acetyl acetonate or combinations thereof

9.-11. (canceled)

12. The method of claim 4, wherein transesterifying the ester pendant group is conducted at a temperature ranging from 150° C. to 300° C., at a pressure ranging from 40 psi to 400 psi, and for a time period ranging from 1 to 18 hours.

13.-21. (canceled)

22. The method of claim 1, wherein the transesterification agent is a metal alkoxide, wherein the metal alkoxide comprises an alkali metal alkoxide, an alkaline earth metal alkoxide or a transition metal alkoxide.

23. The method of claim 22, wherein the metal in the metal alkoxide is selected from the group consisting of sodium, potassium, caesium, magnesium, calcium, aluminum, copper, nickel, tin, titanium, zinc, zirconium, gold, silver, platinum, cobalt, iron, ruthenium and palladium, and wherein the alkoxide in the metal alkoxide comprises methoxide, ethoxide, n-propoxide (nPr), isopropoxide (iPr), butoxide, 2-methylpropoxide or tert-butoxide.

24. (canceled)

25. The method of claim 22, wherein the metal alkoxide comprises sodium tert-butoxide, potassium tert-butoxide, titanium isopropoxide, aluminum ethoxide, aluminum isopropoxide, zirconium ethoxide or combinations thereof.

26. (canceled)

27. The method of claim 22, wherein the transesterification agent further comprises an inorganic base, wherein the inorganic base comprises potassium carbonate, sodium carbonate, caesium carbonate, potassium hydroxide or combinations thereof.

28. (canceled)

29. The method of claim 22, wherein the metal alkoxide is dissolved in a solvent, wherein the solvent comprises n-butanol, ethylene glycol, dimethylformamide (DMF), dioxane, 2-methyl tetrahydrofuran, cyclopentyl methyl ether (CPME), dimethyl sulfoxide, N-methyl-2-pyrrolidone or a mixture thereof.

30. (canceled)

31. The method of claim 22, wherein transesterifying the ester pendant group is conducted at a temperature ranging from 80° C. to 150° C., for a time period ranging from 1 to 24 hours.

32.-34. (canceled)

35. The method of claim 2, wherein R¹ and R⁵ are both methoxy, or R¹ is H and R⁵ is methoxy, wherein R², R⁴ or both are independently H, methyl, ethyl, propyl or butyl, and wherein R³ is H, methyl, ethyl, propyl, butyl, hydroxypropyl, hydroxy butyl, propenyl, butenyl, hydroxypropenyl or hydroxybutenyl.

36.-37. (canceled)

38. The method of claim 2, wherein the phenol derivative of formula (I) has one of the following structures:

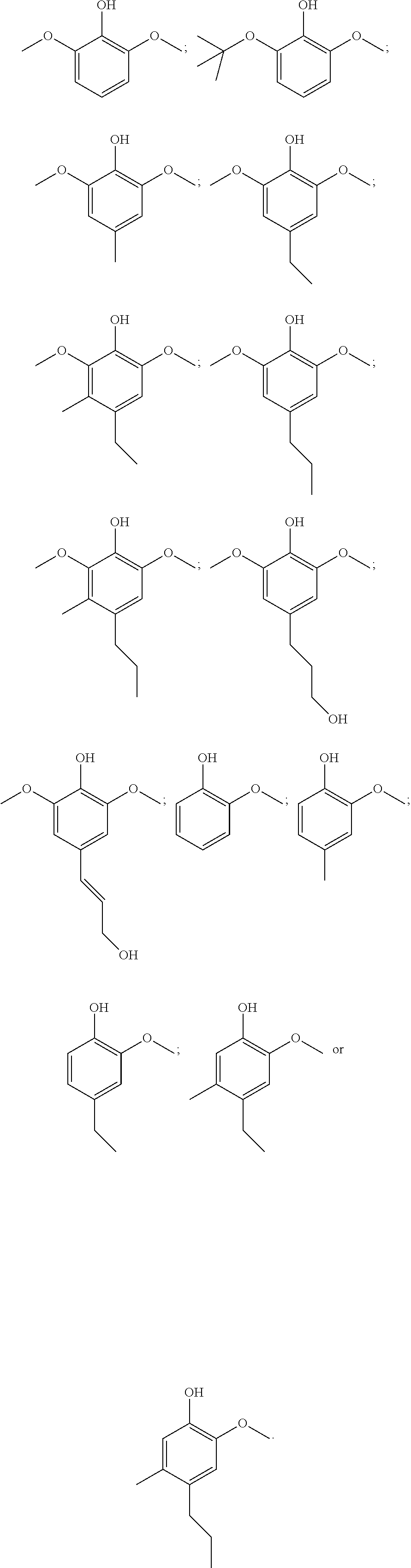

39. (canceled)

40. The method of claim 2, wherein the crosslinked polymeric material comprises a monomeric unit of formula (V): 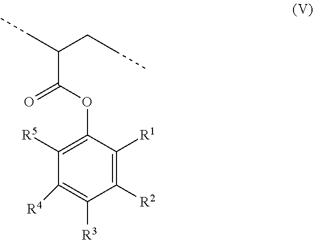
wherein: [symbol]
represents a segment of a backbone of the crosslinked polymeric material; and
R¹, R², R³, R⁴, and R⁵ are each independently H, substituted or unsubstituted C₁₋₁₂ alkyl, substituted or unsubstituted C₁₋₁₂ hydroxyalkyl, substituted or unsubstituted C₂₋₁₂ alkenyl, substituted or unsubstituted C₂₋₁₂ hydroxyalkenyl, substituted or unsubstituted C₁₋₁₂ heteroalkyl, substituted or unsubstituted C₁₋₁₂ alkoxy, substituted or unsubstituted C₁₋₁₂ thioalkoxy, substituted or unsubstituted C₁₋₁₂ carbonyl, substituted or unsubstituted C₁₋₁₂ carboxyl, substituted or unsubstituted cyclo(C₃₋₁₈) alkyl, substituted or unsubstituted cyclo(C₃₋₁₈) heteroalkyl, substituted or unsubstituted aryl or substituted or unsubstituted heteroaryl.

41.-42. (canceled)

43. The method of claim 3, wherein Cy is monocyclic or polycyclic alkyl such as substituted or unsubstituted adamantyl, cyclohexyl, cycloheptyl, cyclooctyl, norbornyl, tricyclodecyl or tetracyclododecyl.

44. The method of claim 3, wherein the cycloaliphatic alcohol derivative of formula (III) has one of the following structures:

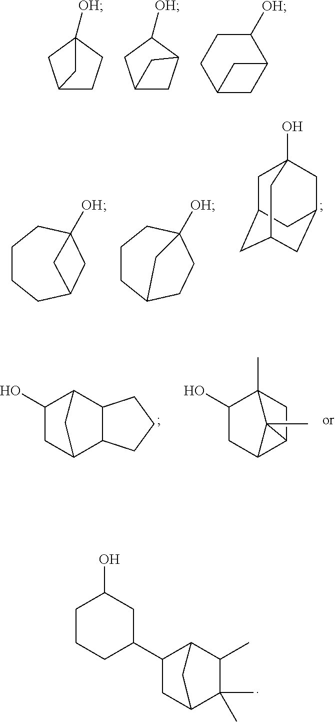

45. The method of claim 3, wherein the crosslinked polymeric material comprises a monomeric unit of formula (VI): 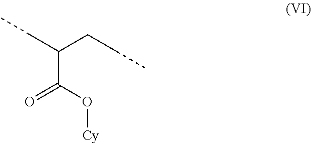
wherein: [symbol]
represents a segment of a backbone of the crosslinked polymeric material; and
Cy is substituted or unsubstituted cyclo(C₃₋₁₈) alkyl.

46. The method of claim 45, wherein the monomeric unit of formula (VI) has one of the following structures:

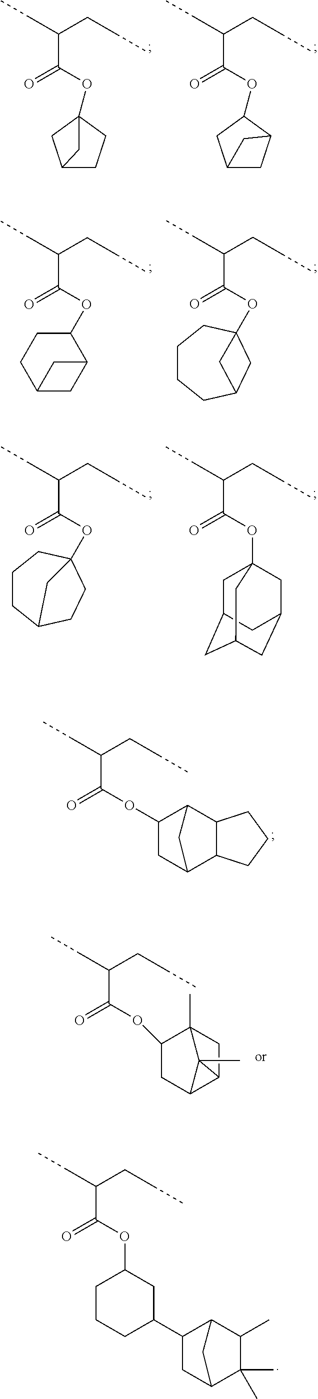

47.-50. (canceled)

51. The method of claim 1, wherein the crosslinked polymeric material has a crosslinking density ranging from 0.00001 to 0.01 mol/g.

52. (canceled)

53. The method of claim 1, further comprising forming the 3D printed object feedstock from a device, wherein the device comprises an aligner, a palatal expander, an attachment, an attachment template, a retainer, a crown, a veneer, an implant, an oral sleep apnea appliance or a mouth guard.

54.-56. (canceled)

57. A method for forming a polymerizable compound, comprising:
providing a curable composition;
curing the curable composition to form a crosslinked polymeric material comprising an ester pendant group derived from a hydroxyl-containing compound;
transesterifying the ester pendant group with a transesterification agent, optionally in the presence of a transesterification catalyst, to form a mixture comprising the hydroxyl-containing compound;
isolating the hydroxyl-containing compound from the mixture; and
forming the polymerizable compound by reacting the hydroxyl-containing compound with a functional group,
wherein the hydroxyl-containing compound is a compound of formula (A): 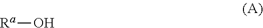
wherein R^{a} is substituted or unsubstituted aryl, substituted or unsubstituted heteroaryl, substituted or unsubstituted cyclo(C3-18) alkyl, substituted or unsubstituted cyclo(C3-18) heteroalkyl or substituted or unsubstituted C1-12 alkylene-cyclo(C3-18) heteroalkyl.

58.-82. (canceled)

83. A method for recovering a (meth)acrylate monomer from a 3D printed object feedstock, comprising:
providing the 3D printed object feedstock comprising a crosslinked polymeric material;
heating the 3D printed object feedstock in the presence of a mechanical energy to depolymerize the crosslinked polymeric material, thereby providing a depolymerization product; and
purifying the depolymerization product to obtain the (meth)acrylate monomer,
wherein the (meth)acrylate monomer has the following formula (B): 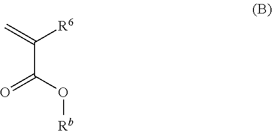
wherein:
R⁶ is H, substituted or unsubstituted C₁₋₃ alkyl or halogen; and
R^{b} is substituted or unsubstituted C₁₋₁₂ alkyl, substituted or unsubstituted C₁₋₁₂ heteroalkyl, substituted or unsubstituted aryl, substituted or unsubstituted heteroaryl, substituted or unsubstituted cyclo(C₃₋₁₈) alkyl, substituted or unsubstituted cyclo(C₃₋₁₈) heteroalkyl or substituted or unsubstituted C₁₋₁₂ alkylene-cyclo(C₃₋₁₈) heteroalkyl, and
wherein the crosslinked polymeric material comprises repeating units derived from the (meth)acrylate monomer of formula (B).

84.-138. (canceled)
